(19) United States
(12) Patent Application Publication
(10) Pub. No.: US 2015/0379226 A1
(43) Pub. Date: Dec. 31, 2015

(54) HEALTH MANAGEMENT SYSTEM, HEALTH MANAGEMENT APPARATUS, AND DISPLAY METHOD

(71) Applicant: PANASONIC INTELLECTUAL PROPERTY MANAGEMENT CO., LTD., Osaka (JP)

(72) Inventor: Satoshi MORINAGA, Kyoto (JP)

(21) Appl. No.: 14/748,001

(22) Filed: Jun. 23, 2015

(30) Foreign Application Priority Data
Jun. 25, 2014 (JP) 2014-130010
Apr. 20, 2015 (JP) 2015-086260

(51) Int. Cl. G06F 19/00

(52) U.S. Cl. CPC G06F 19/3431

(57) ABSTRACT

A health management system for managing health of a user includes an acquiring unit which acquires measurement data generated by measurement of the user; a calculating unit which calculates a health evaluation value according to the measurement data acquired by the acquiring unit, based on a predetermined health evaluation standard for evaluation related to the health of the user; a specifying unit which specifies an object according to the health evaluation value calculated by the calculating unit, the object being an image representing a thing; and a display unit which displays the object specified by the specifying unit.

### CROSS REFERENCE TO RELATED APPLICATIONS

The present application is based on and claims priorities of Japanese Patent Application No. 2014-130010 filed on Jun. 25, 2014, and Japanese Patent Application No. 2015-086260 filed on Apr. 20, 2015. The entire disclosures of the above-identified applications, including the specifications, drawings and claims are incorporated herein by reference in their entireties.

### FIELD

The present disclosure relates to a technique of controlling display of information for health management.

### BACKGROUND

Patent Literature (PTL) 1 discloses a health management system for promoting health, etc. by transmitting, through a network, a varying prediction, diagnosis, and improvement result display screen, to a mobile terminal of a patient and a potential patient of diseases associated with adult lifestyle habits who need continuing efforts in medical treatment.

In addition, PTL 2 discloses a health condition determination device which (i) selects, based on a life index that is an index related to lifestyle habits and the biological index that is an index related to physiological conditions which are acquired by measurement or the like, the biological index which reduces an evaluation of the health conditions of an evaluation object person, as an attention index, (ii) extracts the life index that has the highest correlation to the attention index as an improvable factor from among the past data items of the biological index and the life index, and (iii) displays the improvable factor together with the evaluation on the health conditions to the evaluation object person.

### CITATION LIST

### Patent literature

[PTL 1] Japanese Unexamined Patent Application Publication No. 2004-157596

[PTL 2] Japanese Unexamined Patent Application Publication No. 2010-122901

### SUMMARY

### Technical Problem

The present disclosure provides a health management system and a health management apparatus which display health conditions of a user who is a subject of health management, in an intuitively comprehensible manner, and a display method used in the health management system.

### Solution to Problem

A health management system according to the present disclose is a health management system for managing health of a user, including: an acquiring unit which acquires measurement data generated by measurement of the user; a calculating unit which calculates a health evaluation value according to the measurement data acquired by the acquiring unit, based on a predetermined health evaluation standard for evaluation related to the health of the user; a specifying unit which specifies an object according to the health evaluation value calculated by the calculating unit, the object being an image representing a thing; and a display unit which displays the object specified by the specifying unit.

In addition, a health management apparatus according to the present disclosure is a health management apparatus for managing health of a user, including: a display; and a processor, wherein the processor specifies an object which is an image representing a thing, according to a health evaluation value determined based on measurement data generated by measurement of a user, and transmits a control signal for displaying, on the display, the object which has been specified, and the display displays the object according to the control signal for displaying the object, the control signal being transmitted by the processor.

In addition, a display method according to the present disclosure is a display method performed in a health management system for managing health of a user, including: acquiring measured data generated by measurement of the user; calculating a health evaluation value according to the measured data acquired in the acquiring, based on a predetermined health evaluation standard for evaluation related to the health of the user; specifying an object according to the health evaluation value calculated in the calculating, the object being an image representing a thing; and displaying the object specified in the specifying.

### Advantageous Effects

With the health management system and the like according to the present discloser, an evaluation related to health is replaced with an object and displayed, and thus a user can intuitively comprehend health conditions.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a schematic view illustrating a configuration example of a health management system according to Embodiment 1.

FIG. 2 is a functional block diagram according to the health management system.

FIG. 3 is a diagram illustrating an example of a hardware configuration of a server.

FIG. 4 is a diagram illustrating an example of a hardware configuration of a user terminal.

FIG. 5 is a diagram illustrating an example of the hardware configuration of an instructor terminal.

FIG. 6 is a diagram illustrating an example of a configuration of an instruction subject management table.

FIG. 7 is a diagram illustrating an example of a configuration of an instruction data management table.

FIG. 8 is a diagram illustrating an example of a configuration of a measurement data management table.

FIG. 9 is a diagram illustrating an example of a configuration of an object management table related to a continuity evaluation value.

FIG. 10 is a diagram illustrating an example of a configuration of an object management table related to a health evaluation value.

FIG. 11 is a diagram illustrating another example of the configuration of the object management table related to the health evaluation value.

FIG. 12 is a diagram illustrating yet another example of the configuration of the object management table related to the health evaluation value.

FIG. 13 is a diagram illustrating yet another example of the configuration of the object management table related to the health evaluation value.

FIG. 14 is a flowchart illustrating an operation related to calculation of the health evaluation value and the continuity evaluation value performed by the calculating unit of the server.

FIG. 15 is a diagram illustrating an example of a blood pressure evaluation standard table for use in calculation of a blood pressure parameter.

FIG. 16 is a diagram illustrating an example of a blood glucose level evaluation standard table for use in calculation of a blood glucose level parameter.

FIG. 17 is a diagram illustrating an example of a blood pressure and blood glucose level evaluation standard table for the entire period for use in calculation of an evaluation parameter of a blood pressure and a blood glucose level.

FIG. 18 is a diagram illustrating an example of a blood pressure and blood glucose level evaluation standard table for the last week for use in calculation of an evaluation parameter of a blood pressure and a blood glucose level.

FIG. 19 is a diagram illustrating an example of a body weight evaluation standard table for the entire period for use in calculation of an evaluation parameter of a body weight.

FIG. 20 is a diagram illustrating an example of a body weight evaluation standard table for the last week for use in calculation of an evaluation parameter of a body weight.

FIG. 21 is a diagram illustrating an example of a body weight evaluation standard table for the entire period for use in calculation of an evaluation parameter of an amount of physical activity.

FIG. 22 is a diagram illustrating an example of a body weight evaluation standard table for the last week for use in calculation of an evaluation parameter of a body weight.

FIG. 23 is a diagram illustrating an example of a tendency evaluation standard table for use in calculation of a tendency parameter.

FIG. 24 is a flowchart illustrating an operation related to specifying of an object performed by a specifying unit of the server.

FIG. 25 is a diagram illustrating an example of use of an object related to a continuity evaluation value.

FIG. 26 is a diagram illustrating an example of an object specified according to the evaluation parameter.

FIG. 27 is a diagram illustrating a communication sequence between the devices in the health management system according to Embodiment 1

FIG. 28 is a diagram illustrating an example of displaying an object on the user terminal according to Embodiment 1.

FIG. 29 is a functional block diagram of a server according to Embodiment 2.

FIG. 30 is a diagram illustrating an example of displaying an object on the user terminal according to Embodiment 2.

FIG. 31 is a schematic view illustrating a configuration example of a health management system according to Embodiment 3.

FIG. 32 is a diagram illustrating a communication sequence between the devices in the health management system according to Embodiment 3

FIG. 33 is a diagram illustrating an example of displaying an object on the user terminal according to Embodiment 3.

### DESCRIPTION OF EMBODIMENTS

In order to display health conditions of a user who is a subject of health management in an intuitively comprehensible manner, a health management system according to the present disclosure is a health management system for managing health of a user, including: an acquiring unit which acquires measurement data generated by measurement of the user; a calculating unit which calculates a health evaluation value according to the measurement data acquired by the acquiring unit, based on a predetermined health evaluation standard for evaluation related to the health of the user; a specifying unit which specifies an object according to the health evaluation value calculated by the calculating unit, the object being an image representing a thing; and a display unit which displays the object specified by the specifying unit.

With this configuration, an evaluation related to the health of a user which is generated by measurement is virtualized as (in other words, substituted with) an object which is an image representing a thing, and it is thus possible for the user to view the object and intuitively comprehend a health condition based on experience, knowledge, and the like, related to the thing.

Here, for example, the specifying unit may specify a first image representing a shape of a substance as the object when the health evaluation value is a first value, and specify a second image representing a shape of a substance as the object when the health evaluation value is a second value different from the first value, the second image being different from the first image.

With this configuration, an evaluation related to the health of a user which is generated by measurement is virtualized and displayed as an object which is an image representing a shape of a substance. Here, recognition on a certain value of a substance can be easily shared by humans, and it is thus possible for a user to intuitively comprehend a health condition based on an experience, knowledge, and the like related to the substance, by viewing an object.

In addition, for example, the second image may be an image representing the substance represented by the first image in a different amount.

With this configuration, a difference in evaluations related to the health is represented as a difference in number or amount such as the number and dimensions of a substance, and it is thus possible for a user to intuitively comprehend a health condition by viewing an object.

In addition, the specifying unit may specify, as the object, an image according to the health evaluation value calculated by the calculating unit, the image representing a shape of a substance which is human ingestible and is a factor of deterioration in the health condition related to the measurement data.

With this configuration, when excessive ingestion of specified food and drink (salt, for example) is one of the factors of deterioration in the health condition which is evaluated based on the measured data of a specified type (blood pressure, for example), for example, the health condition is displayed as an image representing the specified food and drink, and thus it is possible to call attention of a user who views the image to the excessive ingestion of the specified food and drink.

In addition, the calculating unit may calculate the health evaluation value to result in a higher value as the measurement data of the user indicates a more favorable health condition, and the specifying unit may specify, as the object, an image representing a shape of a substance which has a higher value as the health evaluation value calculated by the calculating unit is higher.

With this configuration, it is possible for a user to intuitively comprehend the health condition, according to a value which the user senses from viewing the object.

In addition, the specifying unit may specify, as the object, an image corresponding to the health evaluation value calculated by the calculating unit, from among a plurality of images each representing a shape of a substance, based on association information in which the plurality of images are associated in advance on a one-to-one basis with health evaluation values such that the higher the health evaluation value is, the higher value the shape of a substance has.

With this configuration, since association information is determined properly in advance, it is possible for a user to properly comprehend the health condition.

In addition, the calculating unit may calculate the health evaluation value to result in a higher value as the measurement data of the user indicates a more unfavorable health condition, and the specifying unit may specify, as the object, an image representing a shape of a substance which is in a more unfavorable condition as the health evaluation value calculated by the calculating unit is higher.

With this configuration, for example, as the blood glucose level of a user which is obtained by measurement is higher, an object which is an image representing a shape of a substance which is in a more unfavorable condition (building such as a shop which is unnaturally swollen, for example) is displayed, and thus it is possible for a user to intuitively recognize that the health condition is not favorable, by viewing the object.

In addition, the calculating unit may revise the measurement data acquired by the acquiring unit, based on an instruction revision value input by an instructor who provides a health instruction (guidance), and calculate the health evaluation value based on the predetermined health evaluation standard.

With this configuration, an instructor causes the health condition to look more favorable or more unfavorable than in reality, using an instruction revision value, thereby enhancing a motivation of a user for promoting health.

In addition, the health management system may include a user terminal and a server capable of communicating with the user terminal, wherein the server may include: the acquiring unit; the calculating unit; the specifying unit; a storage unit which stores the measurement data acquired by the acquiring unit; and an output unit which transmits the object specified by the specifying unit to the user terminal, the user terminal may include: a communication unit which transmits to the server the measurement data and user identification information in association with each other, and receives the object transmitted by the output unit of the server, the measurement data being generated by the measurement of the user, the user identification information identifying the user; and the display unit which displays the object received by the communication unit, the acquiring unit may acquire the measurement data by receiving the measurement data transmitted by the user terminal, the storage unit may store the measurement data acquired by the acquiring unit, in association with the user identification information transmitted by the user terminal in association with the measurement data, the calculating unit may calculate the health evaluation value related to the health of the user identified by the user identification information, according to the measurement data stored in the storage unit in association with the user identification information, and the output unit may transmit, to the user terminal from which the user identification information identifying the user has been transmitted, the object specified by the specifying unit according to the health evaluation value calculated by the calculating unit, the health evaluation value being related to the health of the user.

With this configuration, a user checks the object displayed on the user terminal, thereby intuitively comprehending an evaluation of the health condition and the like calculated by measurement of the user. In addition, the user terminal may have no function of converting measurement data into a virtual object, as long as a function of communicating with the server is provided. This allows the user terminal to, for example, be reduced in size relatively easily, and be used easily by a user.

In addition, the health management system may further include an instructor terminal for an instructor who provides a health instruction (guidance) to input instruction data, wherein the storage unit may further store an instruction subject management table in which the instructor who provides the health instruction (guidance) is associated with a user who is an instruction subject corresponding to the instructor, the output unit may further transmit the measurement data of the instruction subject corresponding to the instructor to the instructor terminal for the instructor to input the instruction data, the measurement data being stored in the storage unit, the instructor terminal may receive and display the measurement data, and transmit to the server the instruction data which has been input, the acquiring unit may further acquire the instruction data by receiving the instruction data transmitted by the instructor terminal, the output unit may transmit the object to the user terminal together with the instruction data acquired by the acquiring unit, the communication unit may receive the instruction data transmitted by the output unit, and the display unit may display the instruction data received by the communication unit, in addition to the object received by the communication unit.

With this configuration, it is possible for a user to check instruction data from an instructor, which is displayed on the user terminal. More specifically, the health management system is capable of presenting an evaluation related to the health condition to a user who is an instruction subject and receives health guidance (instruction), as an object so that the evaluation is easily and intuitively comprehended.

In addition, the acquiring unit may sequentially acquire the measurement data, the calculating unit may further calculate a continuity evaluation value according to an interval of acquiring of the measurement data by the acquiring unit, based on a predetermined continuity evaluation standard for evaluation related to continuity of the measurement of the user, and the specifying unit may further specify the object according to the continuity evaluation value calculated by the calculating unit.

With this configuration, an evaluation related to continuity of measurement by a user is virtualized and displayed as an object, and it is thus possible for the user to intuitively comprehend the continuity of measurement by viewing the object. This is useful in promoting measurement as a prerequisite for health management.

In addition, the health management system may further include a point providing unit which provides the user with a point usable for receiving a service, according to the continuity evaluation value.

With this configuration, it is possible to enhance motivation of a user for measurement.

In addition, the measurement data may data of at least one of a blood pressure, a blood glucose level, a body weight, and an amount of physical activity.

With this configuration, it is possible for a user to intuitively comprehend the condition of a blood pressure, a blood glucose level, a body weight, or an amount of physical activity, by viewing display of an object.

In addition, the object may be an image representing at least one of a hose, a dam, a road, a shop, a forest, salt, sugar, rice, bread, cake, a cigarette, and an alcoholic beverage.

With this configuration, it is possible for a user to intuitively comprehend the health condition by viewing an object that is an image representing a substance widely known to people (hose, dam, etc.), based on knowledge or the like about the substance.

In addition, a health management apparatus according to the present disclosure is a health management apparatus for managing health of a user, including: a display; and a processor, wherein the processor specifies an object which is an image representing a thing, according to a health evaluation value determined based on measurement data generated by measurement of a user, and transmits a control signal for displaying, on the display, the object which has been specified, and the display displays the object according to the control signal for displaying the object, the control signal being transmitted by the processor.

With this configuration, it is possible for a user to intuitively comprehend the health condition of the user, by viewing an object displayed on the display.

In addition, a display method according to the present disclosure is a display method performed in a health management system for managing health of a user, including: acquiring measured data generated by measurement of the user; calculating a health evaluation value according to the measured data acquired in the acquiring, based on a predetermined health evaluation standard for evaluation related to the health of the user; specifying an object according to the health evaluation value calculated in the calculating, the object being an image representing a thing; and displaying the object specified in the specifying.

With this configuration, it is possible for a user to intuitively comprehend the health condition of the user, by viewing an object that is an image representing a thing, based on experience, knowledge, and the like, related to the thing.

These general and specific embodiments include one or more combinations of an apparatus, a system, a method, an integrated circuit, a computer program, and a computer-readable recording medium.

Hereinafter, non-limiting embodiments are described in greater detail with reference to the accompanying Drawings. However, there are instances where description that is too detailed is omitted. For example, there are instances where detailed description for an already well-known item or redundant description for a substantially equal configuration is omitted. This is for the purpose of preventing the following description from being unnecessarily redundant, and facilitating understanding of those skilled in the art.

It is to be noted that the inventors provide the Drawings and the following description for supporting those skilled in the art to fully understand the present disclosure, and thus do not intend that the Drawings and the following description will limit the subject matter of Claims. In other words, the numerical values, shapes, structural elements, the arrangement and connection of the structural elements, steps, the processing order of the steps, etc. shown in the following embodiments are mere examples, and therefore do not limit the subject matter of the appended Claims and their equivalents. Among the structural elements in the following embodiments, structural elements not recited in any one of the independent claims are described as arbitrary structural elements. In addition, each diagram is a schematic diagram and not necessarily strictly illustrated.

### Embodiment 1

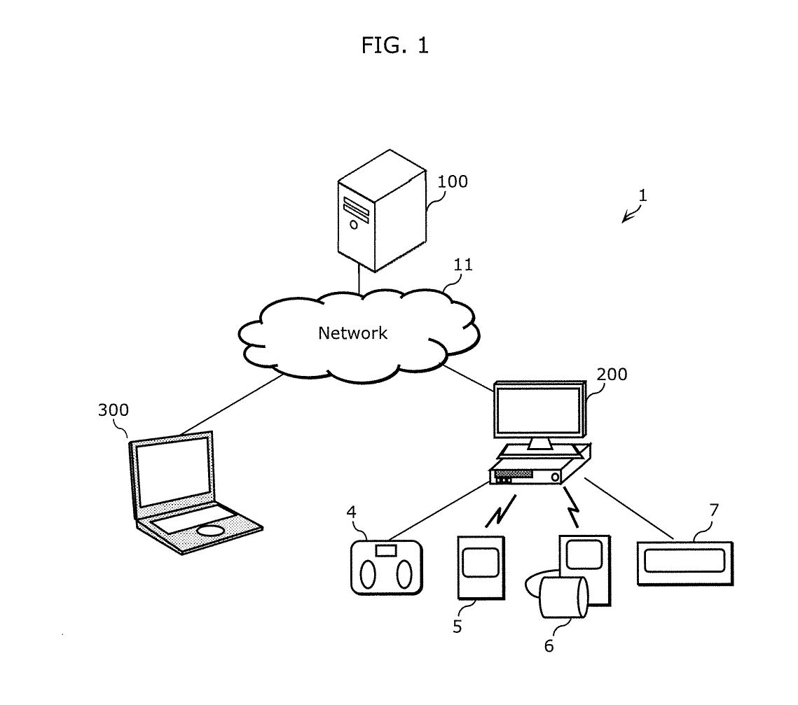

Hereafter, a health management system 1 according to Embodiment 1 will be described with reference to FIG. 1 to FIG. 28.

1-1. Outline of a Health Management System

FIG. 1 is a schematic view illustrating a configuration example of the health management system 1 according to Embodiment 1.

As illustrated in FIG. 1, the health management system 1 includes: a server 100; a user terminal 200; and an instructor terminal 300. The server 100 is capable of communicating with each of the user terminal 200 and the instructor terminal 300 via a network 11. The network 11 may be a wired network or a network including a wireless section, and includes, for example, a wide area communication network such as the Internet. The user terminal 200 is capable of communicating, through wired or wireless communication, with four measuring devices including a weight scale 4 that measures a body weight, a blood glucose meter 5 that measures a blood glucose level, a sphygmomanometer 6 that measures a blood pressure (maximum blood pressure, minimum blood pressure) and a pulse rate, and an activity meter 7 that measures an amount of physical activity and exercise intensity. It is to be noted that, although the user terminal 200 and the instructor terminal 300 are each depicted as a single terminal in FIG. 1 for the purpose of illustration, the health management system 1 may include a plurality of the user terminals 200 and a plurality of the instructor terminals 300.

The health management 1 is a system for managing health of a user. In other words, the health management system 1 is a system which comprehends, based on measurement data generated by measurement of a user, a health condition of the user who uses the user terminal 200, and controls display related to the health condition, and the like. The instructor terminal 300 is used, for inputting information necessary in health guidance (instruction) for the user who is a subject for the instruction, by an instructor who provides instruction (health guidance) for maintenance of health, promotion of health, and the like. The server 100 has a function of, for example, receiving and managing measurement data transmitted from the user terminal 200 (for example, storage and holding), converting the measurement data to a virtual object, and transmitting the virtual object to the user terminal 200. The converting of measurement data to an object is equivalent to specifying an object based on the measurement data. The object is, for example, an image representing a shape of a substance, which will be described later in detail. The health management system 1 allows a user to check, using the user terminal 200, various indications including the object, which are related to a health condition. It is to be noted here that a person who uses the user terminal 200 is referred to as a user or an instruction subject, and a person who uses the instructor terminal 300 is referred to as an instructor.

The weight scale 4, the blood glucose meter 5, the sphygmomanometer 6, and the activity meter 7 illustrated in FIG. 1 are each merely an example of the measuring device, and thus health management of a user may be performed based on measurement data measured by measuring devices other than these four measuring devices, according to the health management system 1. The measuring device is a device which performs measurement of some sort, such as biological information and an amount of activity of a user. Examples of the measuring device other than the above-described four measuring devices are: a weight and body composition scale that measures a body weight, a body composition (body fat, muscle, etc.), BMI (body mass index), and the like; a thermometer that measures a body temperature; a heart rate meter that measures a heart rate; a pedometer that measures the number of steps; a sleep sensor that measures a sleeping state; a calorie counter that counts calories, and so on. Here, the blood pressure, the blood glucose level, the body weight, and the amount of physical activity are mainly used for convenience in the following description.

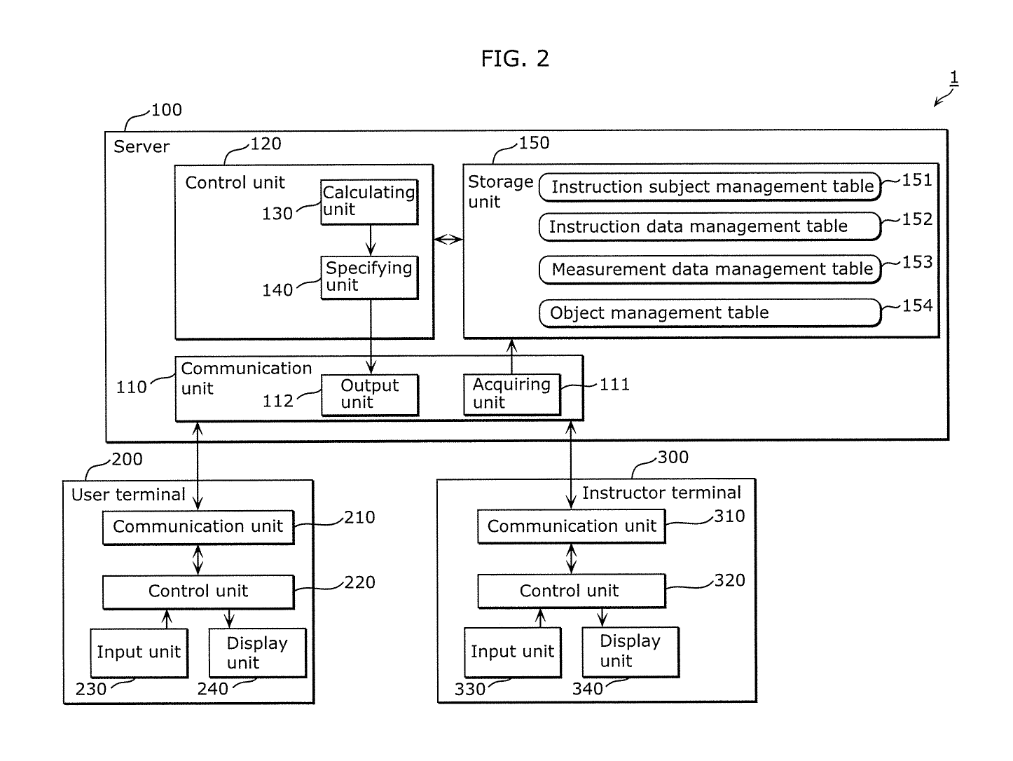

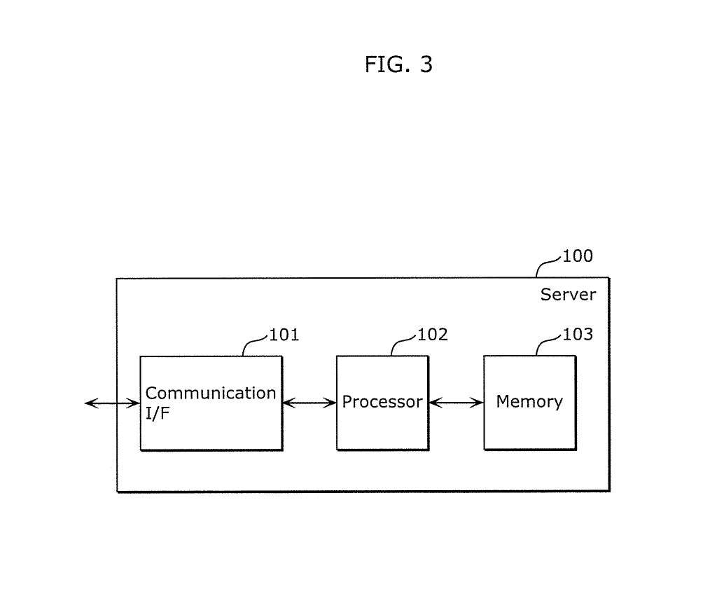

FIG. 2 is a functional block diagram of the health management system 1. The server 100 operates in cooperation with the user terminal 200 and the instructor terminal 300, for example, thereby exerting the functions of the health management system 1. The following describes a configuration of each of the server 100, the user terminal 200, and the instructor terminal 300 included in the health management system 1, with reference to FIG. 2, and FIG. 3 to FIG. 5 illustrating examples of the hardware configuration.

1-1-1. Server

FIG. 3 is a diagram illustrating an example of the hardware configuration of the server 100. The server 100 is a computer including a communication interface (I/F) 101, a processor 102, a memory 103, etc., as illustrated in the diagram. The communication I/F 101 is, for example, a communication circuit for exchanging information with the other devices via the network 11. The processor 102 executes control programs stored in the memory 103, thereby controlling each unit of the server 100 to implement functional processing. The memory 103 is ROM, RAM, etc., and may include a nonvolatile memory. Control programs for implementing each functional processing of the server 100, setting values for use in the control programs, and the like are prestored in these memories, and the memory 103 is also used for temporarily storing each value used in executing the control programs by the processor 102. The server 100 may include, other than the memory 103, a hard disk device and the like.

The server 100 has a function of receiving and managing measurement data generated by measurement of a user and is transmitted by the user terminal 200, specifying an object based on the measurement data, and transmitting the specified object to the user terminal 200. In addition, the server 100 has a function of transmitting measurement data of an instruction subject to the instructor terminal 300, receiving and managing instruction data indicating instruction item, etc., created by an instructor based on the measurement data, and transmitting the instruction data to the user terminal 200. In order to implement the above-described functions, the server 100 functionally includes, as illustrated in FIG. 2, a communication unit 110, a control unit 120, and a storage unit 150, as functional structural elements.

The storage unit 150 is implemented by a storage area of a storage medium such as the memory 103, stores a group of management tables including: an instruction subject management table 151 for managing information of an instruction subject; an instruction data management table 152 for managing instruction data provided by an instructor; a measurement data management table 153 for managing measurement data; and an object management table 154 to be referred to when specifying an object, and may store other data. Here, the instruction data management table 152 and the measurement data management table 153 are prepared for each instruction subject, and the object management table 154 is prepared for each type of the object. The configuration of each of the tables will be described later in detail.

The communication unit 110 is implemented by the processor 102 that executes the control programs, the communication I/F, etc., and has a function of connecting to the network 11 to communicate with the user terminal 200 and the instructor terminal 300. The communication unit 110 includes: an acquiring unit 111 which acquires data by receiving the data transmitted by the user terminal 200 or the instructor terminal 300, and an output unit 112 which transmits, to the user terminal 200 and the like, the data transmitted by the control unit 120.

To be more specific, the acquiring unit 111 acquires the measurement data (for example, measurement data of a body weight, a blood glucose level, a blood pressure, an amount of physical activity, etc., which includes a time and date of the measurement) generated by measurement of a user, by sequentially receiving the measurement data from the user terminal 200. When user identification information (instruction subject ID) is transmitted in association with the measurement data by the user terminal 200, the acquiring unit 111 stores, in the storage unit 150, the measurement data and the user identification information in association with each other, as part of the measurement data management table 153. In addition, the acquiring unit 111 acquires instruction data by receiving the instruction data transmitted by the instructor terminal 300, and stores the instruction data in the storage unit 150 as part of the instruction data management table 152.

The output unit 112 has a function of transmitting an object specified based on the measurement data, to the user terminal 200 which has transmitted the user identification information (instruction subject ID) together with the measurement data, a function of transmitting the measurement data to the instructor terminal 300, and so on.

The control unit 120 is implemented by the processor 102 or the like that executes the control programs, and includes a calculating unit 130 and a specifying unit 140, for converting the measurement data to an object, in other words, for identifying an object based on the measurement data. In addition, the control unit 120 has a function of transferring the measurement data stored in the storage unit 150 to the output unit 112, and causing the output unit 112 to transmit the measurement data to the instructor terminal 300, a function of transferring the object specified by the specifying unit 140, together with the instruction data stored in the storage unit 150, to the output 112, and causing the output unit 112 to transmit the object and the instruction data to the user terminal 200, a function of managing the instruction subject (user) and the instructor in association with each other according to the instruction subject management table 151, and so on.

The calculating unit 130 has a function of calculating, in reference to the measurement data stored in the storage unit 150, a health evaluation value according to the measurement data, based on a predetermined health evaluation standard determined in advance for evaluation on a health of the user; and a function of calculating a continuity evaluation value according to a measurement interval of the measurement data acquired by the acquiring unit 111, based on a predetermined continuity evaluation standard determined in advance for evaluation on continuity of the measurement of the user. It is to be noted that the calculation of the health evaluation value based on the predetermined health evaluation standard and the calculation of the continuity evaluation value based on the predetermined continuity evaluation standard will be described later in detail.

The specifying unit 140 has a function of specifying, in reference to the object management table 154 stored in the storage unit 150, an object which is an image representing, for example, a shape of a substance or the like, according to the health evaluation value and the continuity evaluation value calculated by the calculating unit 130. It is to be noted that the specifying of an object according to the health evaluation value and the continuity evaluation value will be described later in detail.

The control unit 120 may calculate the health evaluation value and the continuity evaluation value calculated using the calculating unit 130, specify the object using the specifying unit 140, and cause the output unit 112 to transmit the specified object and the measurement data when receiving the measurement data, at a time according to a predetermined time, period, etc., or when receiving a request from the user terminal 200 or the instructor terminal 300. For example, when the user terminal 200 accesses the server 100 by transmitting the user identification information (instruction subject ID) to request information related to health management, the control unit 120 may perform a control of selecting, in reference to the management tables in the storage unit 150, a type of an initial screen image (from among the types including a screen image indicating a body weight, a screen image indicating a blood pressure, etc.) to be transmitted in association with the user, and transmitting an object and the like as elements displayed on the screen corresponding to the type of the initial screen image.

1-1-2. User Terminal

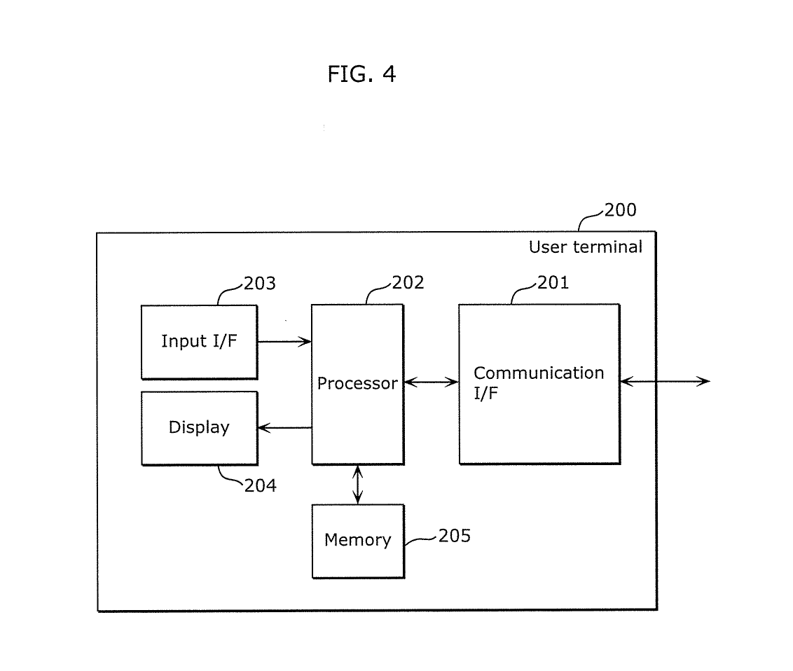

FIG. 4 is a diagram illustrating an example of the hardware configuration of the user terminal 200. The user terminal 200 is a computer including a communication interface (I/F) 201, a processor 202, an input interface (I/F) 203, a display 204, a memory 205, etc., as illustrated in the diagram, and is, for example, a personal computer, smartphone, or the like. The communication I/F 201 is, for example, a communication circuit for exchanging information with the server 100 via the network 11. The processor 202 executes control programs stored in the memory 205, thereby controlling each unit of the user terminal 200 to implement the functional processing. The input I/F 203 is an input device such as a keyboard and a pointing device, which receives an input operation of the user, and when the measurement device such as the weight scale 4, the blood glucose meter 5, the sphygmomanometer 6, and the activity meter 7 has a function of transmitting the measurement data of the user, includes a communication circuit for receiving the measurement data. The measurement device having a function of transmitting the measurement data and the user terminal 200 may communicate with each other using, in addition to wired communication, infrared communication, or wireless communication (the technique of so-called near field communication may be employed). In addition, even when the measurement device does not have the function of transmitting the measurement data, the user (instruction subject) can input the measurement data measured by the measurement device into the user terminal 200 using the input I/F 203. The display 204 is, for example, a liquid crystal display, a plasma display, an organic EL (electroluminescence) display, etc., operates in response to a control signal from the processor 202, and is capable of displaying the object, the instruction data, etc. received by the user terminal 200 from the server 100. The memory 205 is ROM, RAM, etc., and may include a nonvolatile memory. Control programs for implementing each functional processing of the user terminal 200, setting values for use in the control programs, and the like are prestored in these memories, and the memory 205 is also used for temporarily storing each value used in executing the control programs by the processor 202.

The user terminal 200 is used by the user, and includes, as illustrated in FIG. 2, a communication unit 210, a control unit 220, an input unit 230, and a display unit 240, as functional structural elements, in order to receive the measurement data generated by the measurement of the user, transmit the measurement data to the server 100, and receive and display the object and the instruction data transmitted by the server 100.

The communication unit 210 is implemented by the processor 202 that executes the control programs, the communication I/F 201, the memory 205, etc., transmits the measurement data stored in the memory 205 together with user identification information (instruction subject ID) which is provided by the user and uniquely identifies the user (instruction subject), to the server 100, and receives and stores in the memory 205 the object and the instruction data transmitted by the server 100.

The input unit 230 is implemented by the input I/F 203, the memory 205, and the like. The input unit 230 has a function of receiving the user identification information and other information input by the user using an input device, and a function of acquiring the measurement data by receiving the measurement data generated by measurement of the user from the measurement device, or by receiving the measurement data input by the user using the input device, and transferring the acquired measurement data to the control unit 220.

The control unit 220 is implemented by the processor 202 that executes the control programs, the memory 205, etc. The control unit 220 has a function of storing, into the memory 205, the measurement data and the other information transferred by the input unit 230, causing the communication unit 210 to transmit the measurement data to the server 100, and when the object and the instruction data are received by the communication unit 210, causing the display unit 240 to display the object and the instruction data stored in the memory 205. The measurement data may be transmitted to the server 100 according to a predetermined time, period, etc. (for example, once a day, etc.), or upon input by the user.

The display unit 240 is implemented by the display 204 or the like, and has a function of displaying the object and the instruction data stored in the memory 205 under the control of the control unit 220.

1-1-3. Instructor Terminal

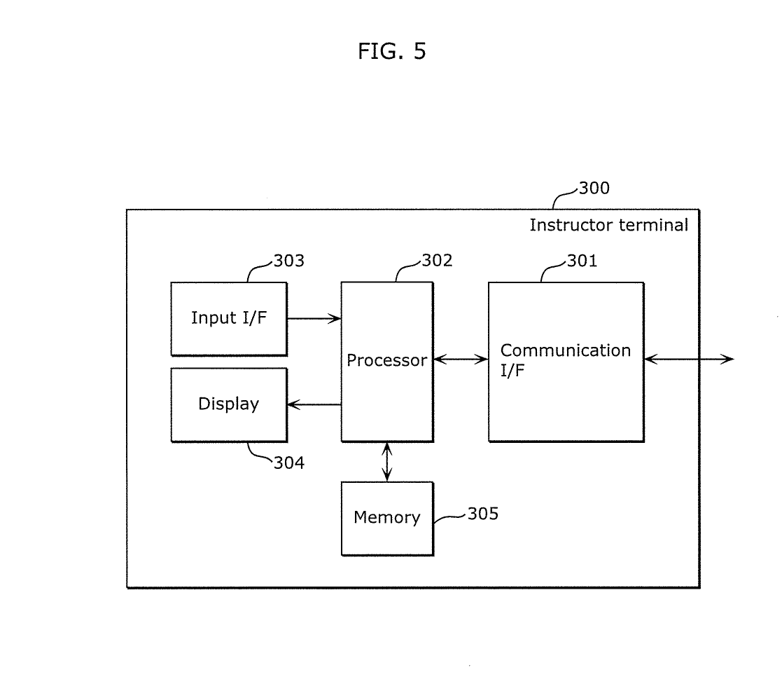

FIG. 5 is a diagram illustrating an example of the hardware configuration of the instructor terminal 300. The user terminal 300 is a computer including a communication interface (I/F) 301, a processor 302, an input interface (I/F) 303, a display 304, a memory 305, etc., as illustrated in the diagram, and is, for example, a personal computer, smartphone, or the like. The communication I/F 301 is, for example, a communication circuit for exchanging information with the server 100 via the network 11. The processor 302 executes control programs stored in the memory 305, thereby controlling each unit of the instructor terminal 300 to implement the functional processing. The input I/F 303 is an input device, such as a keyboard, a pointing device, or the like, which receives an input operation performed by the user. The display 304 is, for example, a liquid crystal display, a plasma display, an organic EL display, etc., and is capable of displaying the measurement data and the like received from the server 100. The memory 305 is ROM, RAM, etc., and may include a nonvolatile memory. Control programs for implementing each functional processing of the instructor terminal 300, setting values for use in the control programs, and the like are prestored in these memories, and the memory 305 is also used for temporarily storing each value used in executing the control programs by the processor 302.

The instructor terminal 300 is used by the instructor, and includes as illustrated in FIG. 2, a communication unit 310, a control unit 320, an input unit 330, and a display unit 340, as functional structural elements, in order to acquire the measurement data of the instruction subject stored in the server 100, and to notify the server 100 of instruction data indicating an instruction item related to health guidance (instruction) to the instruction subject.

The communication unit 310 is implemented by the processor 302 that executes the control programs, the communication I/F 301, the memory 305, and the like, and has a function of receiving the measurement data transmitted by the server 100, storing the received measurement data into the memory 305, and transmitting, to the server 100, the instruction data stored in the memory 305 together with the instructor identification information (instructor ID) input by the instructor and uniquely identifying the instructor.

The input unit 330 is implemented by the input I/F 303, the memory 305, and the like, and has a function of receiving the instructor identification information input by the instructor using the input device, and instruction data indicating an instruction item for the instruction subject, and other information.

The control unit 320 is implemented by the processor 302 that executes the control programs, the memory 305, and the like, and has a function of storing, into the memory 305, the instruction data and the other information transferred to the input unit 330, causing the display unit 340 to display the measurement data stored in the memory 305 when the measurement data is received by the communication unit 310, and causing the communication unit 310 to transmit the instruction data to the server 100. The instruction data may be transmitted to the server 100 according to a predetermined time, period, etc. (for example, once a day, etc.), or upon input by the instructor. In addition, the control unit 320 may request the server 100 for the measurement data according to an input by the instructor. It is to be noted that the server 100 may transmit, instead of the measurement data, a list of the instruction subjects who have transmitted the measurement data, to the instructor terminal 300. In this case, the instructor terminal 300 may display the list, the instructor may specify all or part of the instruction subjects in the list, and the control unit 320 may request the server 100 for the measurement data of the specified instruction subject.

The display unit 340 is implemented by the display 304 or the like, and has a function of displaying the measurement data stored in the memory 305 under the control of the control unit 320. The measurement data may be displayed as a data value using a character string including a number, or may be graphically displayed.

1-2. Management Table

The following described each of the management tables held by the storage unit 150.

1-2-1. Instruction Subject Management Table

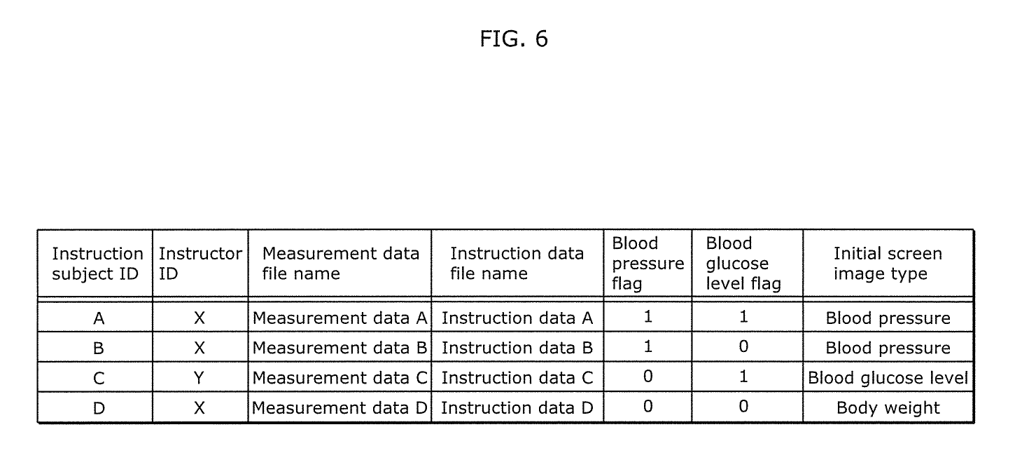

FIG. 6 is a diagram illustrating an example of the configuration of the instruction subject management table 151. The instruction subject management table 151 is specified, for example, in advance by the instructor or the like. It is to be noted that the server 100 which has received the data input by the instructor using the instructor terminal 300 may set or update the details of the instruction subject management table 151 according to the received data.

As illustrated in FIG. 6, the instruction subject management table 151 includes: an instruction subject ID; an instructor ID; a measurement data file name; an instruction data file name; a blood pressure flag; a blood glucose level flag; and an initial screen image type.

The instruction subject ID is an identifier that uniquely indicates an instruction subject (user), in other words, identification information that identifies a user. In addition, the instructor ID is an identifier that uniquely indicates an instructor who provides an instruction subject with health guidance. The example illustrated in FIG. 6 indicates that an instructor of the instruction subjects identified by instruction subject IDs “A”, “B”, “D” (hereinafter referred to as “instruction subject A”, “instruction subject B”, and “instruction subject D”, respectively) is an instructor identified by an instructor ID “X” (hereinafter referred to as “instructor X”). In addition, the example illustrated in FIG. 6 indicates that an instructor of the instruction subject identified by an instruction subject ID “C” (hereinafter referred to as “instruction subject C”) is an instructor identified by an instructor ID “Y”.

The measurement data file name is a name of a file including the details of the measurement data management table 153 for managing the measurement data of the instruction subjects. The instruction data file name is a name of a file including the details of the instruction data management table 152 for managing the instruction data provided by the instructor. According to the example illustrated in FIG. 6, the measurement data of the instruction subject A is managed by the measurement data management table in the file with a name of “measurement data A”. Likewise, the instruction data of the instructor X who is an instructor of the instruction subject A is managed by the instruction data management table in the file with a name of “instruction data A”. It is to be noted that the measurement data file name and the instruction data file name each may be information other than a file name of a corresponding management table, as long as the information is for identifying and accessing the measurement data management table 153 and the instruction data management table 152.

The blood pressure flag is a flag set by the instructor by determining whether or not the instruction subject requires attention particularly to the condition of a blood pressure. For a person who needs to be observed with particular attention, the blood pressure flag is set as “observation-required” (value 1), and for a person who requires only regular observation is set as “regular observation” (value 0). Likewise, the blood glucose level flag is a flag set by the instructor by determining whether or not the instruction subject requires attention particularly to the condition of a blood glucose level. For a person who needs to be observed with particular attention, the blood glucose level flag is set as “observation-required” (value 1), and for a person who requires only regular observation is set as “regular observation” (value 0). The example illustrated in FIG. 6 indicates that the instruction subject A is determined as “observation-required” on the blood pressure and the blood glucose level, the instruction subject B is determined as “observation-required” only on the blood pressure, the instruction subject C is determined as “observation-required” only on the blood glucose level, and the instruction subject D is determined as not “observation-required” on the blood pressure or the blood glucose level (as “regular observation”).

The initial screen image type is information indicating which type of information related to the measurement data, such as the body weight, the blood glucose level, the blood pressure, the amount of physical activity, etc., should be displayed on the user terminal 200 when the instruction subject activates the user terminal 200 or provides the user terminal with a predetermined input for starting viewing of information related to health management, and is determined and set by the instructor. A default value (for example, a blood pressure) may be predetermined for the case where the initial screen image type is not set. When accessed and requested for information related to health management by the user terminal 200, the server 100 is capable of selecting, according to the initial screen image type, an object to be transmitted from among the objects specified based on the measurement data of each type by the specifying unit 140. Although the instruction subject management table 151 described above includes the initial screen image type that specifies information displayed first, information indicating a display order of the body weight, the blood glucose level, the blood pressure, and the amount of physical activity, on the user terminal 200, may be included in addition to the initial screen image type.

1-2-2. Instruction Data Management Table

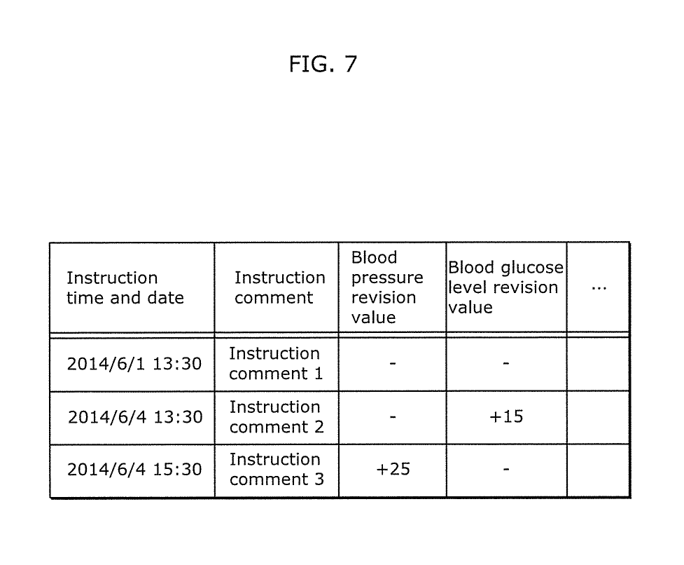

FIG. 7 is a diagram illustrating an example of the configuration of the instruction data management table 152. The instruction data management table 152 is specified for each of the instruction subjects. FIG. 7 illustrates an example of the instruction data management table 152 for one instruction subject.

As illustrated in FIG. 7, the instruction data management table 152 is a set of records (instruction data) including items such as instruction time and date, an instruction comment, a blood pressure revision value, and a blood glucose level revision value. The record includes instruction data transmitted by the instructor terminal 300 to the server 100. For example, the instructor inputs a instruction comment, a blood pressure revision value, and a blood glucose level revision value, onto the instructor terminal 300, the instructor terminal 300 adds time and date of the input as an instruction time and date and transmits the resulting instruction data to the server 100, and the server 100 receives the instruction data, and records the instruction data as one record of the instruction data management table 152.

The instruction comment is information of character strings, etc. including the details of, for example, an advice provided by the instructor to the instruction subject as health guidance (instruction), based on the measurement data of the instruction subject.

The blood pressure revision value is a value used for revising the measurement data (measured value) of a blood pressure of the instruction subject, and causing the instruction subject to recognize the revised measurement data. The measured value is increased or decreased by several percent according to the blood pressure revision value, and the increased or decreased value is used in calculation of the health evaluation value performed by the calculating unit 130. The value “+25” shown in the example in FIG. 7 indicates that a value is to be increased by 25 percent. The blood pressure revision value is set for increasing motivation of the instruction subject to promote health, by revising the measured value of a blood pressure to be different from reality, and making the health condition look better or worse than reality. Likewise, the blood glucose level revision value is a value used for revising the measurement data (measured value) of a blood glucose level of the instruction subject, and causing the instruction subject to recognize the revised measurement data. The instruction data management table 152 may include a revision value for, for example, a body weight, an amount of physical activity, etc. (the various revision values are also referred to as “instruction revision values”), other than the blood pressure and the blood glucose level.

1-2-3. Measurement Data Management Table

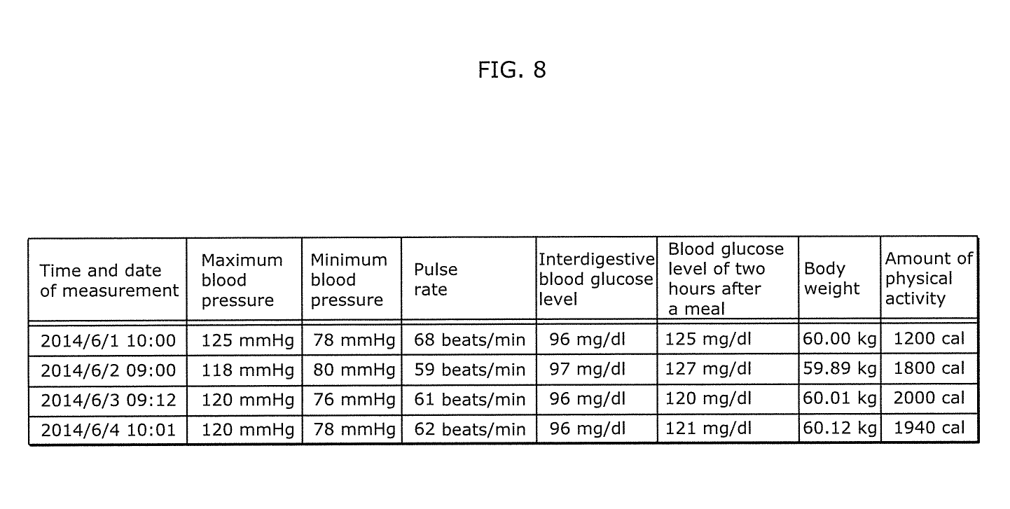

FIG. 8 is a diagram illustrating an example of the configuration of the measurement data management table 153. The measurement data management table 153 is specified for each of the instruction subjects. FIG. 8 illustrates an example of the measurement data management table 153 for one instruction subject.

As illustrated in FIG. 8, the measurement data management table 153 is a set of records (measurement data) including items such as a time and date of measurement, and measured values at the time and date of measurement, such as blood pressures (maximum blood pressure, minimum blood pressure), pulse rate, a blood glucose levels (interdigestive blood glucose level, blood glucose level of two hours after a meal measured when two hours has passed after a meal), a body weight, and an amount of physical activity, etc. The record includes measurement data transmitted by the user terminal 200 to the server 100. For example, the user terminal 200 acquires measurement data by receiving the measurement data from a measurement device, or receiving an input of the instruction subject (user), and transmits to the server 100 the measurement data together with time and date of acquiring the measurement data as time and date of measurement, and the server 100 receives the measurement data and records as one record of the measurement data management table 153.

1-2-4. Object Management Table

The object management table 154 is determined in advance and is prepared for each analysis item for health management, in other words, for each of a health evaluation value and a continuity evaluation value which are calculated by the calculating unit 130. Each of the health evaluation value and the continuity evaluation value may be one parameter or a plurality of parameters. The object management table 154 is a table for use in specifying, by the specifying unit 140 of the server 100, an object to be displayed on the user terminal 200 and presented to a user (instruction subject). The object is, for example, an image representing a shape of a substance. The specifying unit 140 specifies an image (object) from among a plurality of images (objects) as an image (object) to be presented (displayed) to the user. Here, an example is illustrated in which objects which are images representing shapes of a land, a building, etc. in a town, for representing the continuity, the health condition, etc. in a virtualized state of the town.

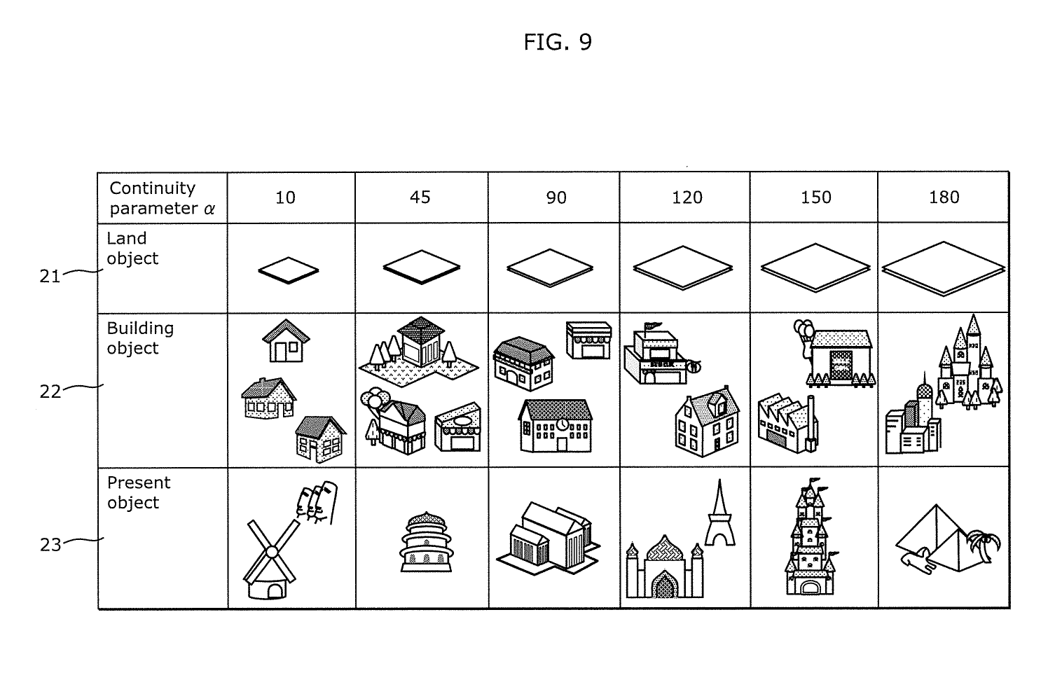

FIG. 9 is a diagram illustrating an example of the configuration of the object management table 154 related to the continuity evaluation value. The object management table 154 illustrated in FIG. 9 is a table in which various objects are associated with values of the continuity evaluation value (continuity parameter α) indicating continuity of measurement of the user. A value of the continuity parameter α (45, for example) illustrated in the diagram may have a range (for example, at least 10 and at most 45), and it is only necessary to create the object management table 154 so as to be used by the specifying unit 140 to specify an object based on the continuity parameter α calculated by the calculating unit 130. The continuity parameter α has a higher value as measurement of the measurement data conducted with a predetermined interval (interval between measurements), one day, for example, continues for a longer period of time. For example, a value of the continuity parameter α increases as the instruction subject continues measurement at least once a day for longer days. In the object management table 154 illustrated in FIG. 9, a land object 21 is an image representing a land as a graphic of a rectangle, and corresponds to a higher value of the continuity parameter α as a size of the rectangle is larger. A building object 22 is an image representing a building (external form of a building, etc.) such as a house and a castle, and corresponds to a higher value of the continuity parameter α as the building is a higher-grade building that is generally considered to have a higher value. A present object 23 is an object assumed to be given to the instruction subject as a present by the instructor. In the example illustrated in FIG. 9, objects which are images each representing a different landmark are associated with the values of the continuity parameter α in one-to-one relationship.

It is to be noted that, other than the continuity parameter α, a frequency parameter which indicates the number of times of measurement per day may be used as the continuity evaluation value. In this case, for example, it is possible to select an object according to a value of the frequency parameter from among a plurality of buildings corresponding to the same value of the continuity parameter α illustrated a the building object 22 in FIG. 9 (for example, a higher-grade building is selected as a value of the frequency parameter is higher).

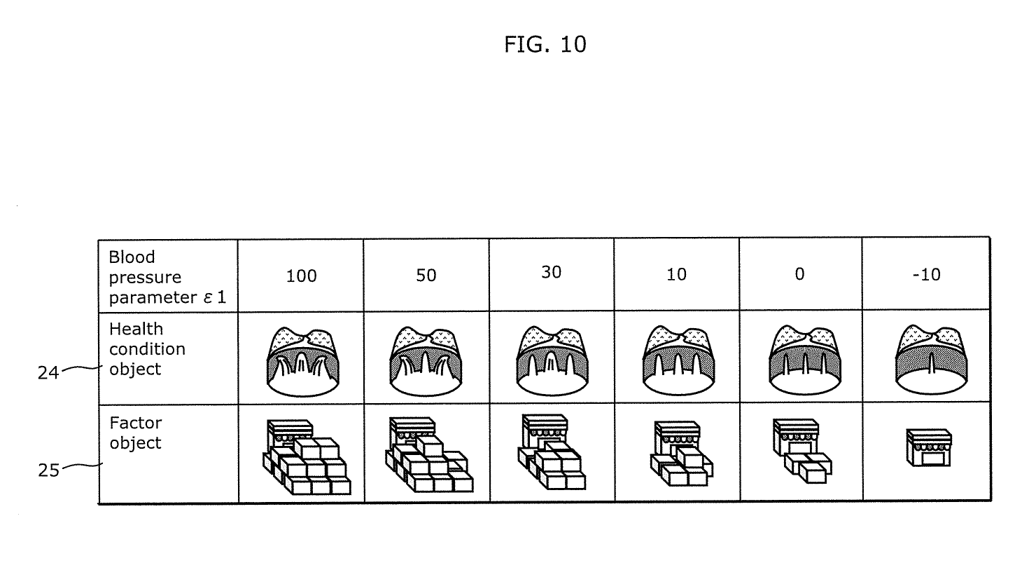

FIG. 10 is a diagram illustrating an example of the configuration of the object management table 154 related to the health evaluation value. The object management table 154 illustrated in FIG. 10 is a table in which various objects are associated with values of the blood pressure parameter ε1 (described later) that is one of the health evaluation values each indicating a health condition of the user. A value of the blood pressure parameter ε1 (50, for example) illustrated in the diagram may have a range (for example, smaller than 100 and at least 50), and it is only necessary to create the object management table 154 so as to be used by the specifying unit 140 to specify an object based on the blood pressure parameter ε1 calculated by the calculating unit 130. In the object management table 154 illustrated in FIG. 10, a health condition object 24 is an image representing a shape of a substance (image representing a dam discharging water), and a discharging amount of water corresponds to a value of the blood pressure parameter ε1. Here, the blood pressure parameter ε1 indicates 0 when the blood pressure is normal. As the blood pressure is higher, the blood pressure parameter ε1 increases and corresponds to the health condition object 24 with a large discharging amount of water. A factor object 25 illustrated in FIG. 10 is an image representing a human ingestible substance which is a factor of deteriorating a state of the blood pressure indicated by the blood pressure parameter ε1 (here, an image representing salt in a salt warehouse). As the image indicates a larger amount of salt stock, the image corresponds to the blood pressure parameter ε1 indicating a higher value (in other words, higher blood pressure). The factor object 25 and the blood pressure parameter ε1 are associated with each other so as to suggest that more attention is required to ingestion of salt as the blood pressure is higher.

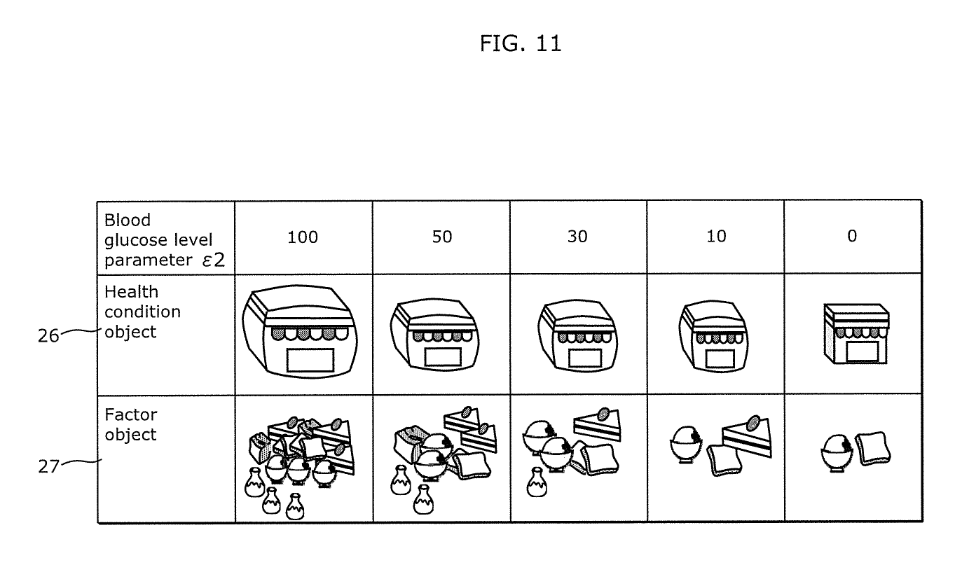

FIG. 11 is a diagram illustrating another example of the configuration of the object management table 154 related to the health evaluation value. The object management table 154 illustrated in FIG. 11 is a table in which various objects are associated with values of the blood glucose level ε2 (described later) that is one of the health evaluation values each indicating a health condition of the user. A value of the blood glucose level ε2 (50, for example) illustrated in the diagram may have a range (for example, smaller than 100 and at least 50), and it is only necessary to create the object management table 154 so as to be used by the specifying unit 140 to specify an object based on the blood glucose level ε2 calculated by the calculating unit 130. In the object management table 154 illustrated in FIG. 11, a health condition object 26 is an image representing a shape of a substance (image representing a shop which sells food and drink), and a degree of being swollen of the shop corresponds to a value of the blood glucose level ε2. Here, the blood glucose level parameter ε2 indicates 0 when the blood glucose level is normal. As the blood glucose level is higher (as the blood sugar is higher), the blood glucose level parameter ε2 increases and corresponds to the health condition object 26 indicating a shop that is greatly swollen. A factor object 27 illustrated in FIG. 11 is an image representing a human ingestible substance such as food and drink, which is a factor of deteriorating a state of the blood glucose level indicated by the blood glucose level parameter ε2 (here, an image representing cake, white rice, bread, alcohol, etc.). As the image indicates a larger amount of food and drink that is a factor of high blood glucose level, the image corresponds to the blood glucose level parameter ε2 indicating a higher value. The factor object 27 and the blood glucose level parameter ε2 are associated with each other so as to suggest that it is more necessary to refrain from taking too-much sweets such as cakes, white rice, bread, alcohol, etc., as the blood glucose level is higher.

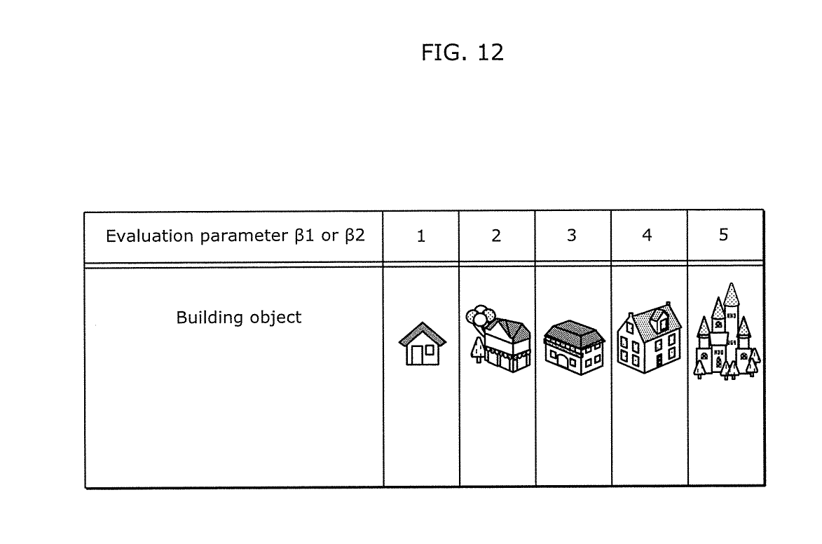

FIG. 12 is a diagram illustrating yet another example of the configuration of the object management table 154 related to the health evaluation value. The object management table 154 illustrated in FIG. 12 is a table in which the building objects are associated with values of evaluation parameters β1 or β2 (described later) each of which is a health evaluation value indicating a health condition of the user. The evaluation parameters β1 and β2 are each determined to have a higher value as the health condition is more favorable, on the scale of one to five. In the object management table 154 illustrated in FIG. 12, the building object is an image representing a building (external form of a building, etc.) such as a house and a castle, and corresponds to a higher value of the evaluation parameter as the building is a higher-grade building that is generally considered to have a higher value. As in the object management table 154 illustrated in FIG. 12, when the specifying unit 140 specifies an object using association information in which images representing shapes of substances are associated in advance respectively with health evaluation values such that the higher the health evaluation value, the higher value the shape of a substance represented by the image has, an advantageous effect is produced which allows a user to intuitively comprehend a health condition and the like indicated by the health evaluation value upon viewing the object which has been specified. It is to be noted that, in determining the object management table 154 illustrated in FIG. 12 etc., the value of a thing represented by an object (for example, a building), in addition to being evaluated based on knowledge, experience, etc., may be determined based on, for example, a questionnaire survey of people, etc., or by reference to a decision made by a user or an instructor.

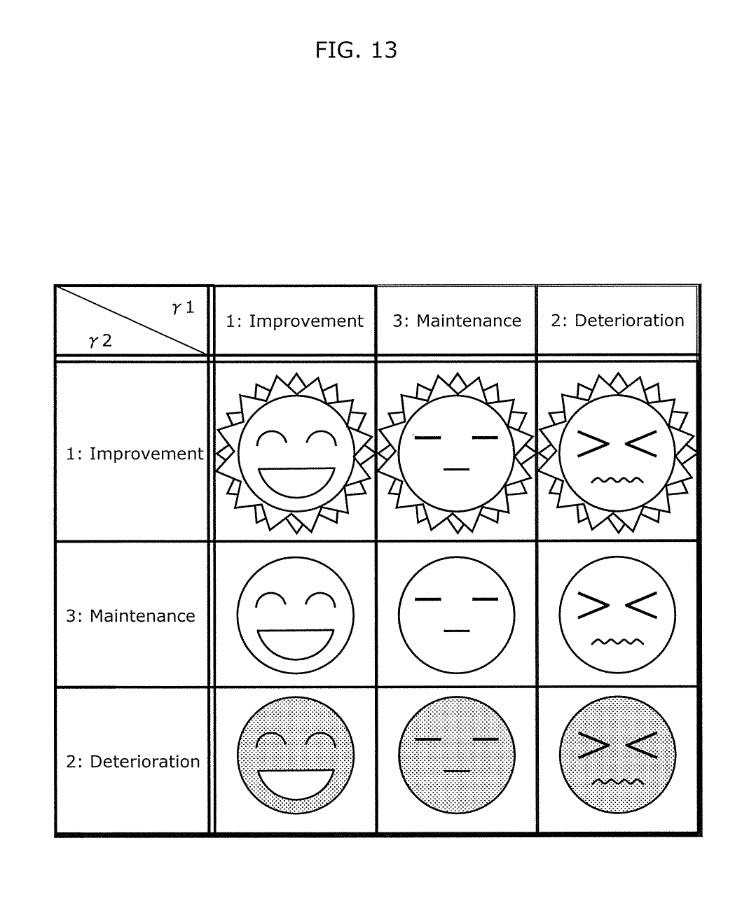

FIG. 13 is a diagram illustrating yet another example of the configuration of the object management table 154 related to the health evaluation value. The object management table 154 illustrated in FIG. 13 is a table in which objects are associated with values of tendency parameters γ1 and γ2 each of which is a health evaluation value indicating a health condition of the user. The tendency parameter γ1 is an evaluation value which determines whether the health condition changes for the better, the health condition is maintained, or the health condition changes for the worse, over the entire period in which the instructor provides instruction to the instruction subject. In addition, the tendency parameter γ2 is an evaluation value which determines whether the health condition changes for the better, the health condition is maintained, or the health condition changes for the worse, over the last week. The object management table 154 illustrated in FIG. 13 is created so as to specify an object in combination of the tendency parameter γ1 and the tendency parameter γ2, and includes a plurality of face objects such that a facial expression changes according to the tendency parameter γ1 and brightness changes according to the tendency parameter γ2. For example, when the tendency parameter γ1 which indicates the tendency over the entire period indicates improvement, the face object expresses smile. When the tendency parameter γ1 indicates maintenance, the face object expresses a normal expression. When the tendency parameter γ1 indicates deterioration, the face object expresses a down expression. In addition, when the tendency parameter γ2 which indicates the tendency over the last week indicates improvement, the face object is gold (not illustrated) with halo. When the tendency parameter γ2 indicates maintenance, the face object is gold without halo. When the tendency parameter γ2 indicates deterioration, the face object is gray.

1-3. Operation of the Calculating Unit (Calculation of the Health Evaluation Value and the Continuity Evaluation Value)

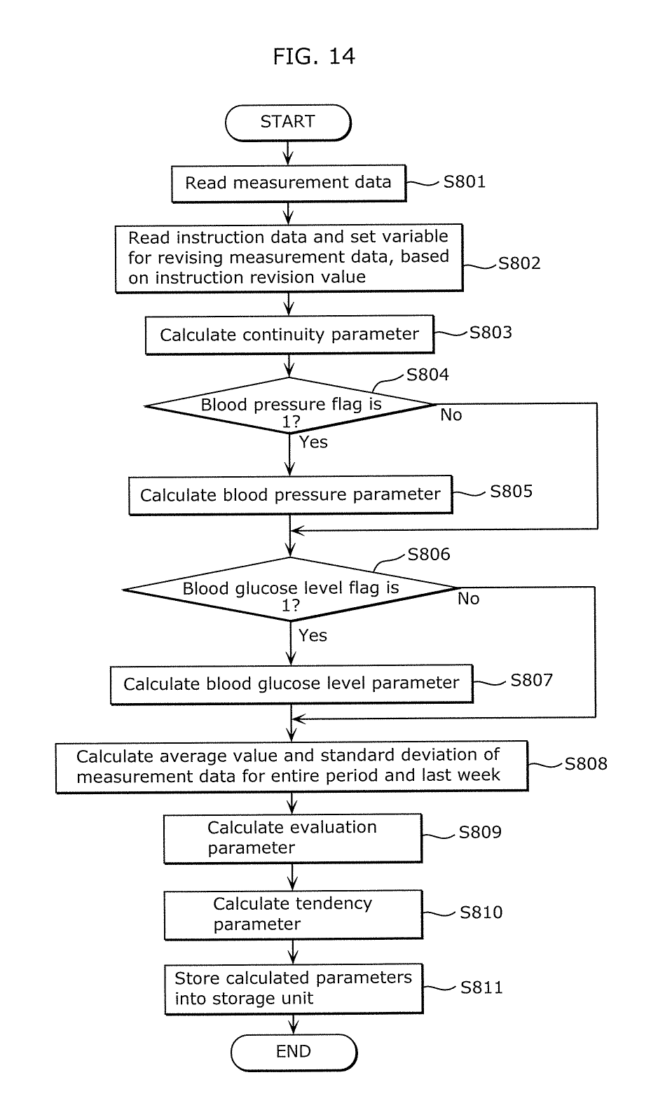

FIG. 14 is a flowchart illustrating an operation related to calculation of the health evaluation value and the continuity evaluation value performed by the calculating unit 130 of the server 100.

The following describes, with reference to FIG. 14, the operation related to calculation of each of the parameters (blood pressure parameter ε1, blood glucose level value parameter ε2, continuity parameter α, etc.) each of which is the health evaluation value or the continuity evaluation value, performed by the calculating unit 130.

For example, upon receiving a request from the user terminal 200 or the like, or with predetermined cyclical timing, the calculating unit 130 of the control unit 120 calculates a parameter based on a plurality of items of the measurement data generated by sequential measurement of an instruction subject. The parameter of the health evaluation value is a parameter used for evaluation related to health of the user, and calculated based on a predetermined health evaluation standard (i.e., a calculation method of which an example is described below). In addition, the parameter of the continuity evaluation value is a parameter used for evaluation related to continuity of measurement of the user, and calculated based on a predetermined continuity evaluation standard (i.e., a calculation method of which an example is described below). The range of measurement data used as the basis of calculation includes: today (present) that is the day of calculation; a period from the day a week earlier to today (hereinafter referred to as “last week”), and a period from an instruction starting day (first measurement day) to today (hereinafter referred to as “entire period”).

The following description exemplifies the case where the control unit 120 calculates, using the calculating unit 130, a parameter based on measurement data of an instruction subject A.

First, the calculating unit 130 acquires, from the instruction subject management table 151 stored in the storage unit 150, a file name of the measurement data management table 153 which manages measurement data of the instruction subject A, and a file name of the instruction data management table 152 which manages instruction data for the instruction subject A. Then, the calculating unit 130 specifies the measurement data management table 153 using the file name of the measurement data management table 153 of the instruction subject A, and reads the measurement data of the instruction subject A included in the measurement data management table 153 (Step S801).

Next, the calculating unit 130 specifies an instruction data management table 152 using the file name of the instruction data management table 152 of the instruction subject A, and reads the instruction data for the instruction subject A included in the instruction data management table 152. Then, the calculating unit 130 sets, for each of the blood pressure, the blood glucose level value, the body weight, and the amount of physical activity, a variable ω (instruction revision value ω) for revising the measurement data, based on the instruction revision value included in the instruction data (Step S802). More specifically, the variable ω is set to the instruction revision value when the instruction revision value is specified for each of the blood pressure, the blood glucose level, the body weight, and the amount of physical activity, and is set to 0 when the instruction revision value is not specified. In calculation of parameters, a measured value of the measurement data is multiplied by ω/100+1 using the variable ω, for example. When the variable ω (instruction revision value ω) of the blood pressure is 25, the measured values (maximum blood pressure p1 and minimum blood pressure p2) of the blood pressure in the measurement data is multiplied by 1.25, and the following procedure of calculating a parameter (Step S802, etc.) is carried out.

In addition, the calculating unit 130 calculates a continuity parameter α that indicates continuity of measurement of the measurement data based on a predetermined continuity evaluation standard, according to the measurement data of the measurement data management table 153 for the instruction subject A (Step S803). For example, the number of consecutive days in each of which measurement is carried out at least once is specified as a continuity parameter α, using the time and date of measurement in the measurement data management table 153. For example, in the case where the measurement is carried out for 10 consecutive days, the continuity parameter α is 10. It is to be noted that the continuity parameter α may be calculated so as to include the above-described frequency parameter. In this case, the continuity parameter α may be calculated by a predetermined function f (α1, α2) using the number of consecutive days α1 in each of which the measurement is carried out at least once and an average measurement frequency α2 per day. The predetermined function f is determined in advance so that, for example, the continuity parameter α increases as the number of consecutive days α1 is larger when the average measurement frequency α2 per day is the same, and the continuity parameter α increases as the average measurement frequency α2 is higher when the number of consecutive days α1 is the same.

The calculating unit 130 determines whether or not the blood pressure flag of the instruction subject A in the instruction subject management table 151 is set to 1 that indicates observation-required (Step S804), calculates the blood pressure parameter ε1 when the blood pressure flag is set to 1 (Step S805), and skips the calculation of the blood pressure parameter ε1 (Step S805) when the blood pressure flag is not set to 1.

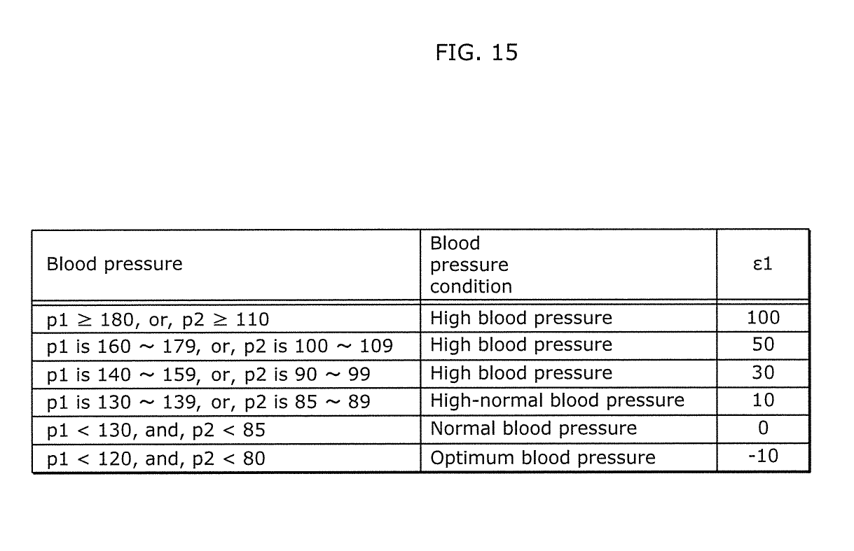

The calculation of the blood pressure parameter ε1 in Step S805 is carried out based on a blood pressure evaluation standard table as a predetermined health evaluation standard. FIG. 15 is a diagram illustrating an example of the blood pressure evaluation standard table. The blood pressure evaluation standard table is a table in which blood pressures (maximum blood pressure p1, minimum blood pressure p2) are associated with the blood pressure parameter ε1. In the blood pressure evaluation standard table according to the example in FIG. 15, it is determined that the blood pressure parameter ε1 is calculated as 100 when the maximum blood pressure p1 is at least 180 (mmHg) or the minimum blood pressure p2 is at least 110 (mmHg), for example. In FIG. 15, what a value of the blood pressure parameter ε1 indicates is described in the field of a blood pressure condition. According to the example illustrated in FIG. 15, when the calculated blood pressure parameter ε1 100, high blood pressure is indicated at the blood pressure condition. In Step S805, the calculating unit 130 calculates the blood pressure parameter ε1 based on the blood pressure evaluation standard table, by setting, for example, the values of the maximum blood pressure and the minimum blood pressure measured today (for example, when the measurement is carried out only once, the resulting measured values are determined as the values, and when the measurement is carried out several times, the average values are determined as the values) as the maximum blood pressure p1 and the minimum blood pressure p2, respectively.

The calculating unit 130 determines whether or not the blood glucose level flag of the instruction subject A in the instruction subject management table 151 is set to 1 that indicates observation-required (Step S806), calculates the blood glucose level parameter ε2 when the blood glucose level flag is set to 1 (Step S807), and skips the calculation of the blood glucose level parameter ε2 (Step S807) when the blood glucose level flag is not set to 1.

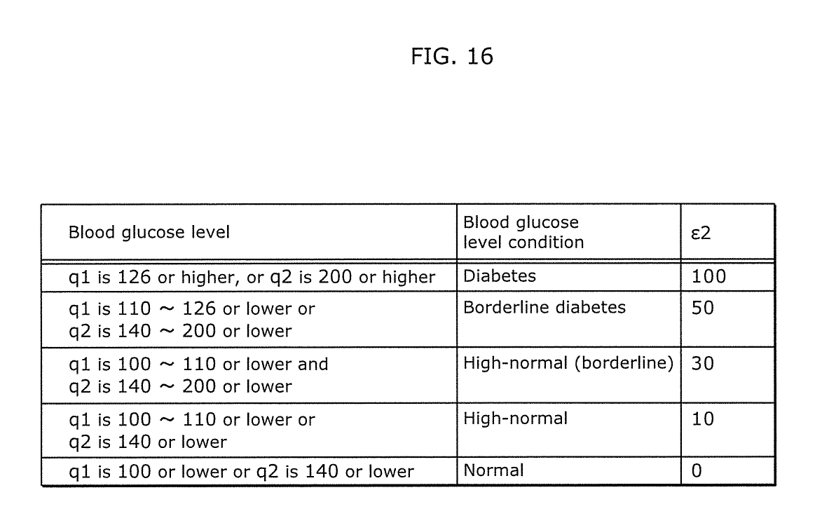

The calculation of the blood glucose level parameter ε2 in Step S807 is carried out based on a blood glucose level evaluation standard table as a predetermined health evaluation standard. FIG. 16 is a diagram illustrating an example of the blood glucose level evaluation standard table. The blood glucose level evaluation standard table is a table in which the blood glucose levels (interdigestive blood glucose level q1, two-hour postprandial blood glucose level q2) are associated with the blood glucose level parameter ε2. In the blood glucose level evaluation standard table according to the example in FIG. 16, it is determined that the blood glucose level parameter ε2 is calculated as 100 when the interdigestive blood glucose level q1 is at least 126 (mg/dl) or the two-hour postprandial blood glucose level q2 is at least 200 (mg/dl), for example. In FIG. 16, what a value of the blood glucose level parameter ε2 indicates is described in the field of a blood glucose level condition. According to the example illustrated in FIG. 16, when the calculated blood glucose level parameter ε2 is 100, the blood glucose level condition corresponds to diabetes. The calculating unit 130 calculates the blood glucose level parameter ε2 based on the blood glucose level evaluation standard table, based on the interdigestive blood glucose level q1 and the two-hour postprandial blood glucose level q2 which are measured today (average values when the measurement is carried out several times), for example. It is to be noted that the blood glucose level evaluation standard table illustrated in FIG. 16 is a mere example of the method of calculating the blood glucose level parameter ε2, and thus only one of the interdigestive blood glucose level q1 and the two-hour postprandial blood glucose level q2 may be used, for example. In addition, the instruction subject or the instructor may determine which one of the blood glucose levels is to be measured. It is to be noted that, in the case where it is not distinctively shown whether the blood glucose level in the measurement data is the interdigestive blood glucose level or the two-hour postprandial blood glucose level, the calculating unit 130 may determine that the blood glucose level is the interdigestive blood glucose level or the two-hour postprandial blood glucose level, based on the time and date of measurement (period of time of measurement, etc.) according to a predetermined standard.

In addition, the calculating unit 130 calculates an average value and a standard deviation of the measurement data (measured value) of each of the blood pressure, the blood glucose level, the body weight, and the amount of physical activity, for each of the entire period and the last week (Step S808).

Next, the calculating unit 130 calculates the evaluation parameter β1 and the evaluation parameter β2 for each of the blood pressure, the blood glucose level, the body weight, and the amount of physical activity (Step S809). The evaluation parameter β1 is calculated by evaluating the today's measurement data (measured value) using the average value and the standard deviation for the entire period. The evaluation parameter β2 is calculated by evaluating the today's measurement data (measured value) using the average value and the standard deviation for the last week.

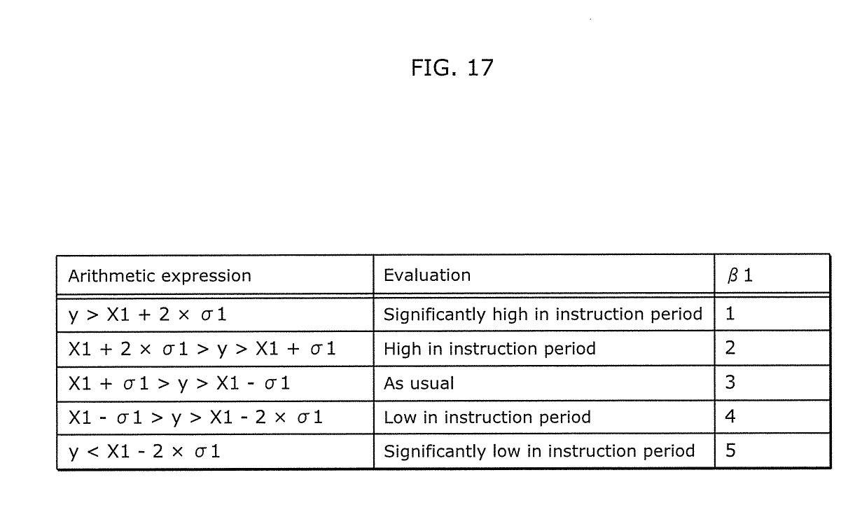

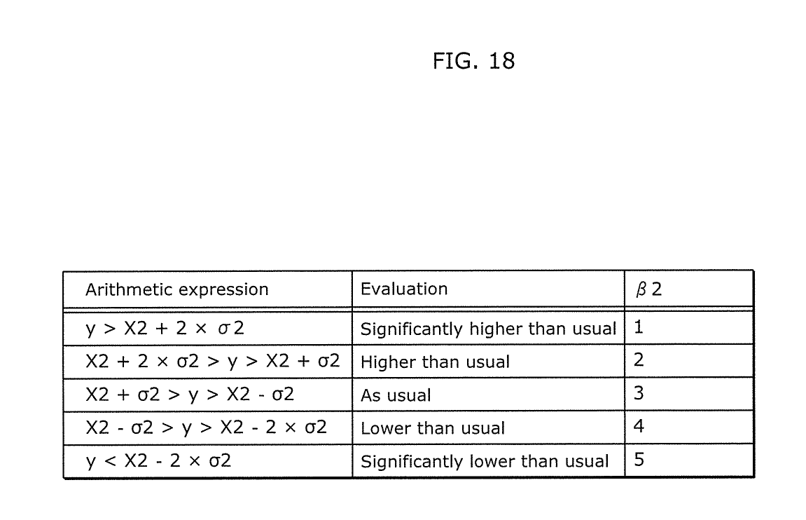

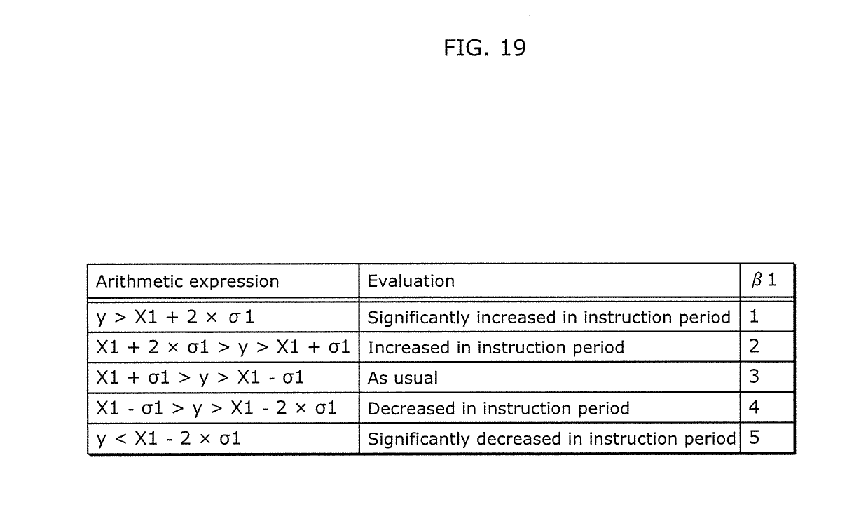

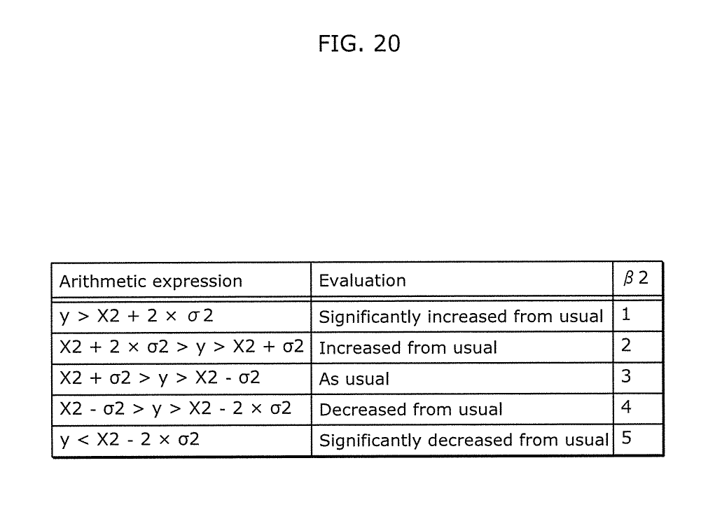

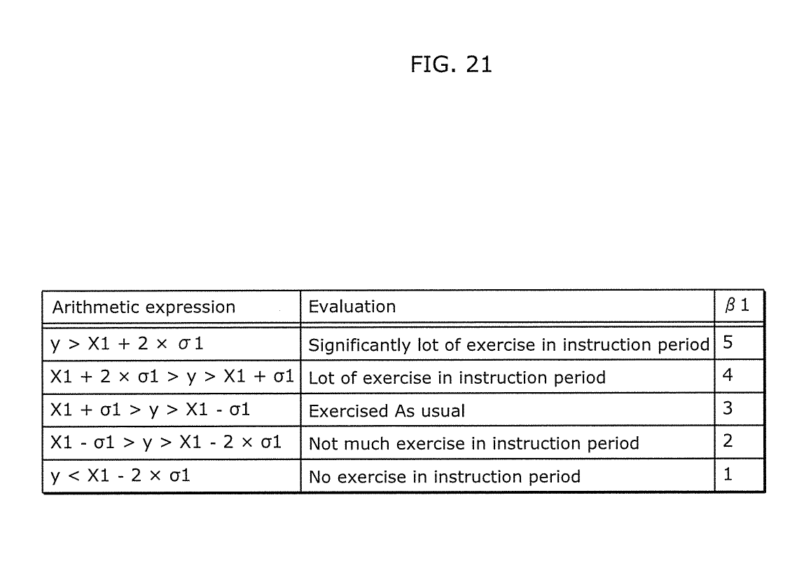

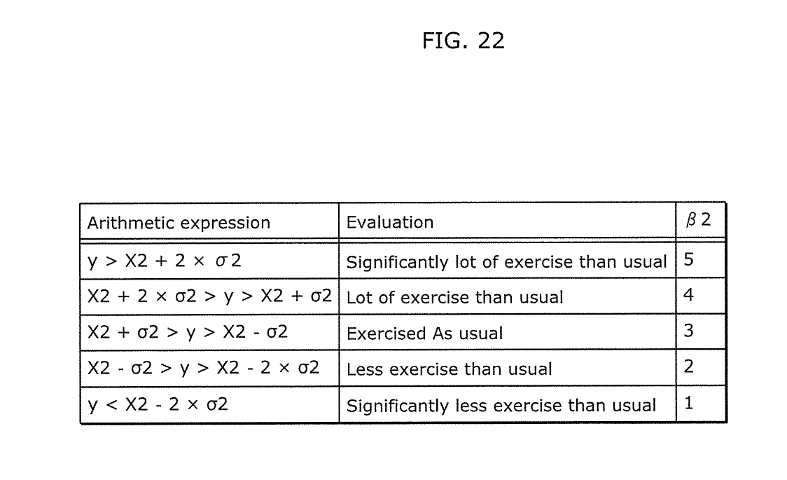

In Step S809, the calculating unit 130 calculates, for each of the blood pressure and the blood glucose level, the evaluation parameter β1 using a blood pressure and blood glucose level evaluation standard table for the entire period illustrated in FIG. 17, and the evaluation parameter β2 using a blood pressure and blood glucose level evaluation standard table for the last week illustrated in FIG. 18. In the tables illustrated in FIG. 17 and FIG. 18, y denotes a blood pressure or a blood glucose level measured today, X1 denotes an average value of blood pressures or blood glucose levels for the entire period, σ1 denotes a standard deviation of blood pressures or blood glucose levels for the entire period, X2 denotes an average value of blood pressures or blood glucose levels for the last week, and σ2 denotes a standard deviation of blood pressures or blood glucose levels for the last week. In addition, in Step S809, the calculating unit 130 calculates, for the body weight, the evaluation parameter β1 using a body weight evaluation standard table for the entire period illustrated in FIG. 19, and the evaluation parameter β2 using a body weight evaluation standard table for the last week illustrated in FIG. 20. In the tables illustrated in FIG. 19 and FIG. 20, y denotes a body weight measured today, X1 denotes an average value of body weights for the entire period, σ1 denotes a standard deviation of body weights for the entire period, X2 denotes an average value of body weights for the last week, and σ2 denotes a standard deviation of body weights for the last week. In addition, in Step S809, the calculating unit 130 calculates, for the amount of physical activity, the evaluation parameter β1 using an amount of physical activity evaluation standard table for the entire period illustrated in FIG. 21, and the evaluation parameter β2 using an amount of physical activity evaluation standard table for the last week illustrated in FIG. 22. In the tables illustrated in FIG. 21 and FIG. 22, y denotes an amount of physical activity measured today, X1 denotes an average value of amounts of physical activity for the entire period, σ1 denotes a standard deviation of amounts of physical activity for the entire period, X2 denotes an average value of amounts of physical activity for the last week, and σ2 denotes a standard deviation of amounts of physical activity for the last week. As described above, the evaluation parameters β1 and β2 are each determined to have a higher value as the health state is more favorable (FIG. 17 to FIG. 22). Here, a health state which is favorable refers to a state favorable for maintenance and improvement of health, such as a state of being healthy, a state of increasingly approaching to the state of being healthy, a state of sufficiently conducting activities for approaching to the state of being healthy.

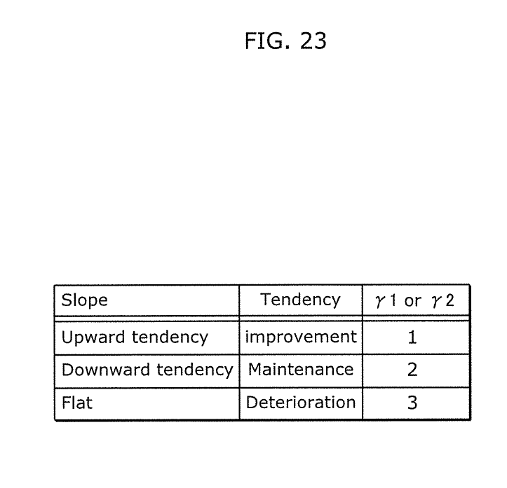

Next, the calculating unit 130 calculates the tendency parameter γ1 and the tendency parameter γ2 for each of the blood pressure, the blood glucose level, the body weight, and the amount of physical activity (Step S810). The tendency parameter γ1 indicates a tendency of change in the measurement data for the entire period. The tendency parameter γ2 indicates a tendency of change in the measurement data for the last week. More specifically, the calculating unit 130 obtains a slope direction of distribution of the measured value (for example, a slope of a regression line calculated by the method of least squares) with respect to elapsed time (the number of elapsed days) by performing regression analysis of the measurement data for the entire period, and calculates the tendency parameter γ1 using a tendency evaluation standard table illustrated in FIG. 23. Likewise, the calculating unit 130 obtains a slope direction of distribution of the measured value with respect to elapsed time by performing regression analysis of the measurement data for the last week, and calculates the tendency parameter γ2 using the tendency evaluation standard table.

Lastly, the calculating unit 130 stores each of the calculated parameters into the storage unit 150 (S811).

1-4. Operation of the Specifying Unit (Specifying of an Object)

The specifying unit 140 of the server 100 specifies an object using the object management table 154, according to each of the parameters of the health evaluation value and the continuity evaluation value which are calculated by the calculating unit 130.

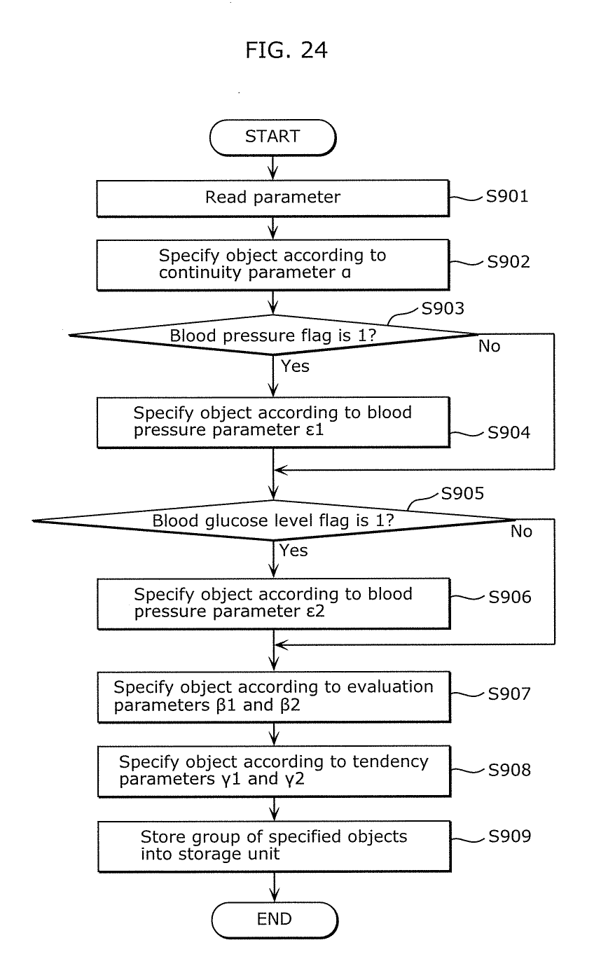

FIG. 24 is a flowchart illustrating an operation related to specifying of an object performed by the specifying unit 140 of the server 100.

The following describes an operation related to specifying of an object performed by the specifying unit 140 with reference to FIG. 24. The following description exemplifies the case where the control unit 120 specifies, using the specifying unit 140, an object based on the measurement data of the instruction subject A.

First, the specifying unit 140 reads each of the parameters calculated by the calculating unit 130 from the storage unit 150 (Step S901).

Next, the specifying unit 140 specifies an object according to the object management table 154 (see FIG. 9) for the continuity evaluation value, according to the value of the continuity parameter α (Step S902). According to the example illustrated in FIG. 9, as the continuity parameter α indicates a higher value, the land object 21 of a rectangle having a larger size that indicates a larger land is specified, and the building object 22 representing a higher-grade building is specified. In addition, the present object 23 which represents a land mark different for each value of the continuity parameter α is specified.

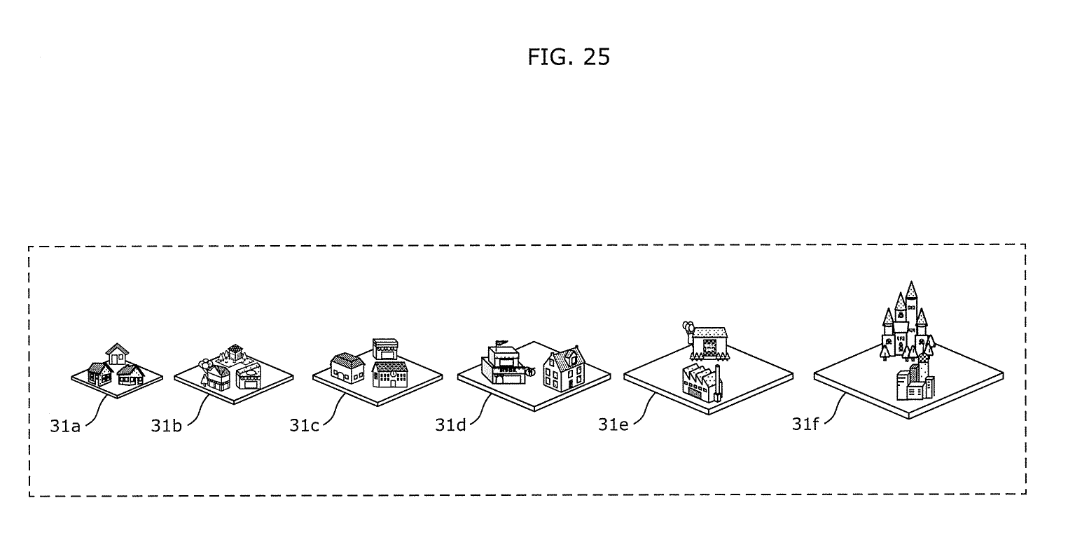

FIG. 25 is a diagram illustrating an example of use of an object related to the continuity evaluation value. In FIG. 25, town objects 31a to 31f are town objects corresponding to 10, 45, 90, 120, 150, and 180, respectively, of the continuity parameters α. These town objects includes a combination of the land object 21 and the building object 22 illustrated in FIG. 9. As illustrated in FIG. 25, as the continuity parameter α indicates a higher value, the town has a larger area, and the building in the town is higher-grade. The town object described above is transmitted by the server 100 to the user terminal 200, and displayed on the user terminal 200. Accordingly, the continuity parameter α which is the continuity evaluation value gradually increases by a continuous measurement performed by the user (instruction subject), and a town increasingly becoming higher-grade is displayed on the user terminal 200. This is useful for enhancing motivation of the instruction subject for continuing the measurement.

Next, the specifying unit 140 determines whether or not the blood pressure flag of the instruction subject A in the instruction subject management table 151 is set to 1 that indicates observation-required (Step S903), specifies an object according to the blood pressure parameter ε1 when the blood pressure flag is set to 1 (Step S904), and skips the specifying of an object according to the blood pressure parameter ε1 (Step S904) when the blood pressure flag is not set to 1. The specifying of an object according to the blood pressure parameter ε1 in Step S904 is carried out based on the object management table 154 related to the blood pressure parameter ε1 (see FIG. 10). According to the example illustrated in FIG. 10, as the blood pressure parameter ε1 is higher, the health condition object 24 which is an image representing a dam with a larger discharging amount of water is specified. In addition, as the blood pressure parameter ε1 is higher, the factor object 25 which is an image representing a salt warehouse having a larger amount of salt stock is specified.

Next, the specifying unit 140 determines whether or not the blood glucose level flag of the instruction subject A in the instruction subject management table 151 is set to 1 that indicates observation-required (Step S905), specifies an object according to the blood glucose level parameter ε2 when the blood glucose level flag is set to 1 (Step S906), and skips the specifying of an object according to the blood glucose level parameter ε2 (Step S906) when the blood glucose level flag is not set to 1. The specifying of an object according to the blood glucose level parameter ε2 in Step S906 is carried out based on the object management table 154 related to the blood glucose level parameter ε2 (see FIG. 11). According to the example illustrated in FIG. 11, as the blood glucose level parameter ε2 is higher, the health condition object 26 which is an image representing a shop that is more swollen is specified. In addition, as the blood glucose level parameter ε2 is higher, the factor object 27 which is an image representing a larger amount of food and drink that is a factor of high blood glucose level is specified.

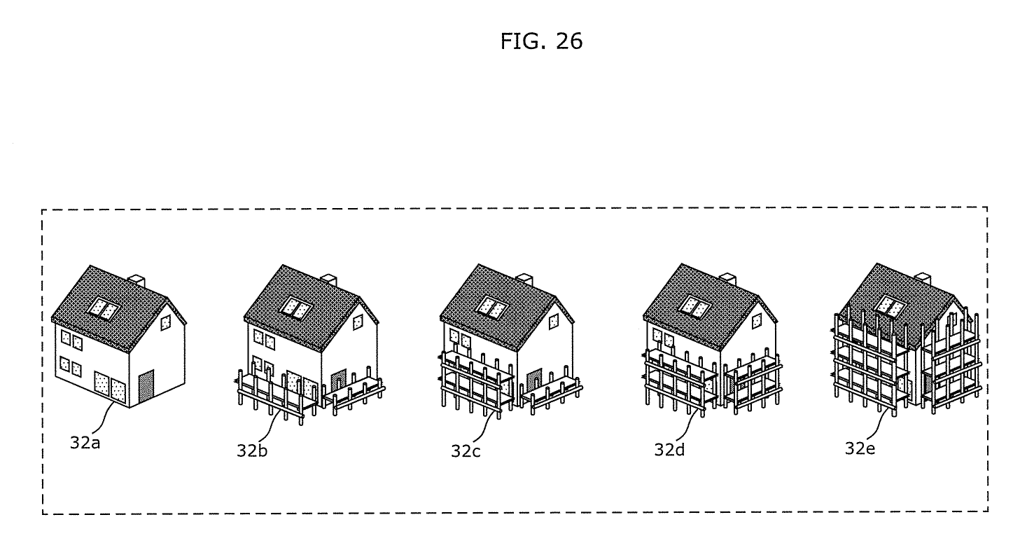

Next, the specifying unit 140 specifies an object according to the evaluation parameters β1 and β2 (Step S907). More specifically, the specifying unit 140 specifies an object according to the object management table 154 for the evaluation parameters β1 and β2 (see FIG. 12). According to the example illustrated in FIG. 12, as the evaluation parameter β1 or the evaluation parameter β2 is higher, a building object which is an image representing an external form of a higher-grade building is specified. It is to be noted that, in Step S907, the specifying of an object may be performed according to only one of the evaluation parameters β1 and β2 for each of the blood pressure, the blood glucose level, the body weight, and the amount of physical activity, or may be performed according to the evaluation parameters for at least one of the blood pressure, the blood glucose level, the body weight, and the amount of physical activity. In addition, an object which is an image representing the necessity of repair work (a portion that needs to be repaired, or the like) for a building may be specified according to a value of the evaluation parameter. FIG. 26 illustrates an example of objects specified according to the evaluation parameters in this case. Building objects 32a to 32e illustrated in FIG. 26 are objects specified according to different values of the evaluation parameters. The building objects 32a to 32e are each an image representing the state where a building is under repair work. For example, as a value of the evaluation parameter indicates not a favorable but a more unfavorable health condition (for example, a state where the health condition requires more attention), an object which is an image representing a building with more repair portions may be specified. It is to be noted that the buildings under repair work illustrated in FIG. 26 are each a mere example, and an object may be specified using an expression that represents a state different from a normal state other than repair work, such as an expression that represents a state where a building is collapsed.

Next, the specifying unit 140 specifies an object according to the tendency parameters γ1 and γ2 (Step S908). More specifically, the specifying unit 140 specifies a face object based on the object management table 154 (see FIG. 13) for the tendency parameters γ1 and γ2, for each of the blood pressure, the blood glucose level, the body weight, and the amount of physical activity.

Lastly, the specifying unit 140 stores each of the specified objects into the storage unit 150 (S909). As described above, each of the objects stored in the storage unit 150 is transmitted by the control unit 120 to the output unit 112, and then transmitted by the output unit 112 to the user terminal 200 used by the instruction subject A.

1-5. Overall Operation of the Health Management System

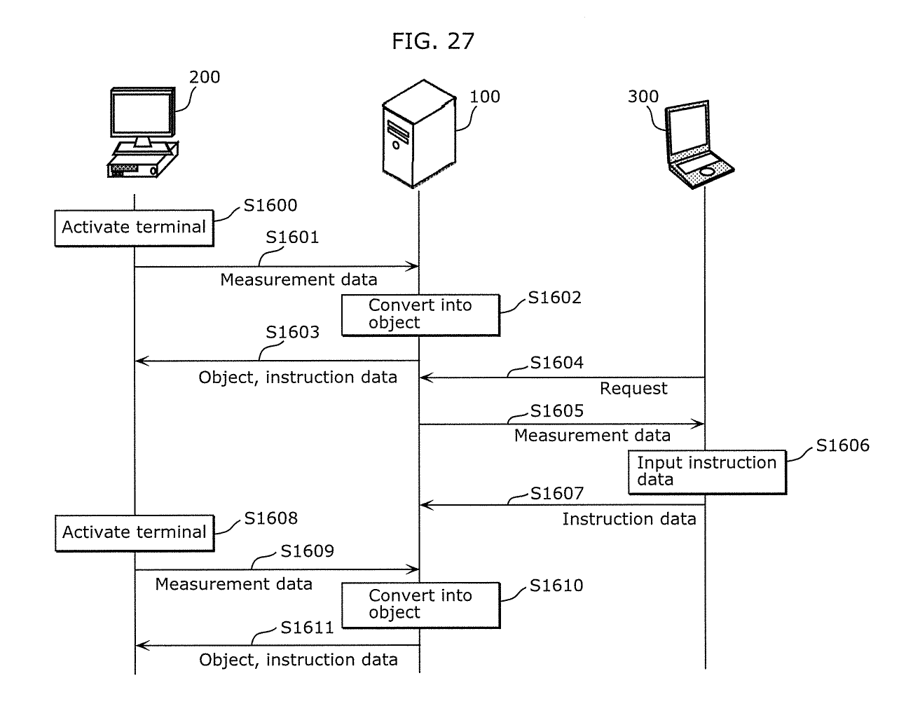

FIG. 27 is a diagram illustrating a communication sequence between the devices in the health management system 1. The following describes a cooperative operation between the user terminal 200, the server 100, and the instructor terminal 300 with reference to FIG. 27.

The instruction subject (user) measures a blood pressure, a blood glucose level, a body weight, and an amount of physical activity, using the respective measurement devices, once or several times a day, for example. The user terminal is activated (Step S1600), and when measurement data is provided by the measurement devices or the user to the user terminal 200, the user terminal transmits, to the server 100, together with a time and date of measurement and an instruction subject ID added to the measurement data (Step S1601).

The server device 100 stores the measurement data received from the user terminal 200 as part of the measurement data management table 153 in the storage unit 150. The server 100 converts the measurement data into an object, in other words, calculates various parameters as health evaluation values and continuity evaluation values based on the measurement data and specifies objects according to the parameters (Step S1602), adds, to the objects, instruction data when the instruction data is already exists, and transmits the objects to the user terminal 200 which has transmitted the instruction subject ID (Step S1603). The user terminal 200 displays the received objects and the liked.

When a request for the measurement data (request including the instructor ID) is received from the instructor terminal 300 (Step S1604), the server 100 specifies, in reference to the instruction subject management table 151, an instruction subject who is the target of instruction of the instructor who uses the instructor terminal 300, extracts the measurement data of the instruction subject from the measurement data management table 153, and transmits the extracted measurement data to the instructor terminal 300 (Step S1605).

The instructor terminal 300 displays the measurement data received from the server 100, and the instructor views the measurement data and inputs instruction data including the details of health guidance (instruction comments, etc.) to the instruction subject, into the instructor terminal 300 (Step S1606). When a plurality of instruction subjects who are the targets of instruction of the instructor are exist, the instructor terminal 300 receives and displays the measurement data of the plurality of instruction subjects from the server 100, and thus the instructor inputs the instruction data for each of the instruction subjects.

Upon receiving the input of the instruction data, the instructor terminal 300 adds a time and date of instruction to the instruction data and transmits the data to the server 100 (Step S1607). The server 100 stores and manages the instruction data received from the instructor terminal 300 as part of the instruction data management table 152 in the storage unit 150.

For example, the instruction subject activates the user terminal 200 for measuring data at the timing of the next measurement, for example, one day later and several hours later. As with the operation in Step S1601, the user terminal 200 transmits the measurement data to the server 100 (Step S1609). As with the operation in Step S1602, the server 100 calculates various parameters as the health evaluation values and the continuity evaluation values, reflecting the currently received measurement data and previously received measurement data, and specifies objects according to the parameters (Step S1610). The server 100 extracts, in reference to the instruction data management table 152 in the storage unit 150, the instruction data received in Step S1607, and transmits the instruction data together with the objects to the user terminal 200 (Step S1611). Then, the user terminal 200 displays the received objects and the instruction data.

The transmitting of the object from the server 100 in Step S1603 and Step S1611 is transmitting of some of the objects specified in Step S1602 or Step S1610, for example, and the object which is a subject of the transmitting is an object selected according to the initial screen image type of the instruction subject management table 151 in the storage unit 150. Although it is omitted in FIG. 27, the server 100 subsequently receives a request for transmitting the next screen image from the user terminal 200, selects the remaining objects, and transmits the selected objects. It is to be noted that the transmitting of objects from the server 100 in Step S1603 and Step S1611 may be transmitting of all of the objects specified in Step S1602 or Step S1610, for example. in this case, prior to displaying the objects transmitted from the server 100, the user terminal 200 checks the initial screen image type which has been set in the instruction subject management table in the server 100, and displays first an object corresponding mainly to the type (for example, one of a blood pressure, a blood glucose level, a body weight, and an amount of physical activity) corresponding to the initial screen image type. When it is desired to display a type of the measurement data which is not displayed on the initial screen image, the instruction subject (user) performs a predetermined operation to cause the user terminal 200 to display an object corresponding to the measurement data of a different type. The predetermined operation may be carried out by, for example, displaying a switching button for switching screen images in the screen image, and receiving an operation of pressing the switching button.

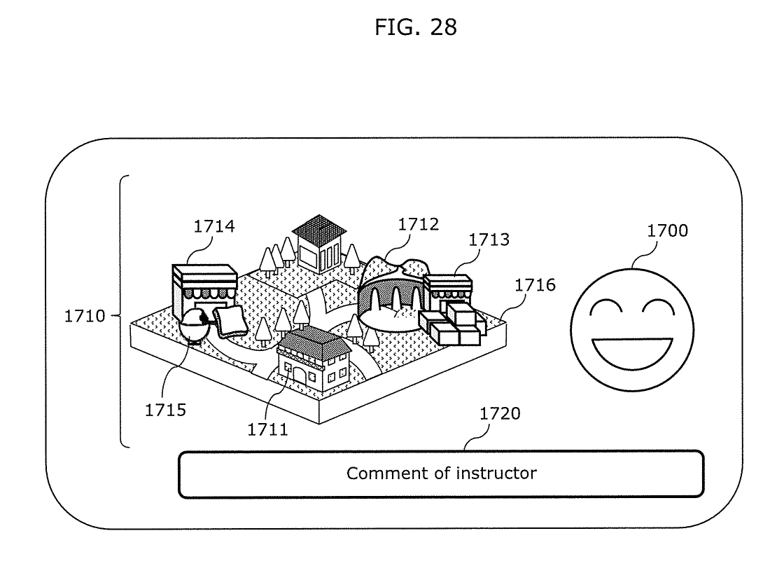

FIG. 28 is a diagram illustrating an example of displaying an object on the user terminal 200. FIG. 28 illustrates an example of the initial screen image displayed on the user terminal 200 used by the instruction subject A indicated in the instruction subject management table 151 in FIG. 6. The initial screen image type is a blood pressure.

In the example illustrated in FIG. 28, a face object 1700 indicating a tendency of health conditions is displayed in the upper right of the screen image, an object group 1710 indicating evaluation resulting from continuity and health conditions is displayed in the upper left of the screen image, and instruction data (instruction comment) 1720 from the instructor is displayed in the bottom of the screen image. The object group 1710 includes a land object 1716 representing continuity, a building object and the like disposed above the land object 1716. The building object 1711 indicating the present (today's) health condition (state of the blood pressure corresponding to the initial screen image type) is disposed in front of the land object 1716, and the health condition object, the factor object, etc. corresponding to the measurement data of each of the types which are set to be displayed are disposed in other places. The face object 1700 based on the tendency parameter indicates the tendency that the blood pressure is favorable for the entire period and the state of the blood pressure is maintained for the last week (see FIG. 13). The building object 1711 based on the evaluation parameter indicates that the evaluation of the present state of the blood pressure is three on the scale of one to five (see FIG. 12). In addition, the health condition object 1712 indicates that the present blood pressure is high-normal, and the factor object 1713 indicates that the necessity of attention to excessive ingestion of salt is not particularly high (see FIG. 10 and FIG. 15). In addition, the health condition object 1714 indicates that the blood glucose level is in the normal state, and the factor object 1715 indicates that attention to excessive ingestion of sugar is not necessary (see FIG. 11 and FIG. 16). It is to be noted that the object group 1710 may include a present object (see FIG. 9) as a present from the instructor to the instruction subject. Since the object transmitted to the user terminal 200 by the control unit 120 of the server 100 using the output unit 112 is an image, the object group 1710 including a plurality of objects can be handled as an object that is an image including a plurality of partial images.

1-6 Advantageous Effect

As described above, in the health management system 1 according to Embodiment 1, the acquiring unit 111 acquires measurement data generated by measurement of a user (instruction subject) and stores the measurement data into the storage unit 150. In addition, the calculating unit 130 calculates a health evaluation value according to the measurement data acquired by the acquiring unit 111, based on a predetermined health evaluation standard (see FIG. 15 to FIG. 23) for evaluation related to health of the user. The specifying unit 140 specifies an object according to the health evaluation value calculated by the calculating unit 130. Then, the specified object is displayed on the display unit 240 of the user terminal 200.

With this, it is possible to convert the measurement data generated by the measurement of the user (instruction subject) into a virtualized object, and display the object. Thus, it is possible present information related to the health condition of the user in such a manner that the information can be intuitively comprehended by the user.

### Embodiment 2

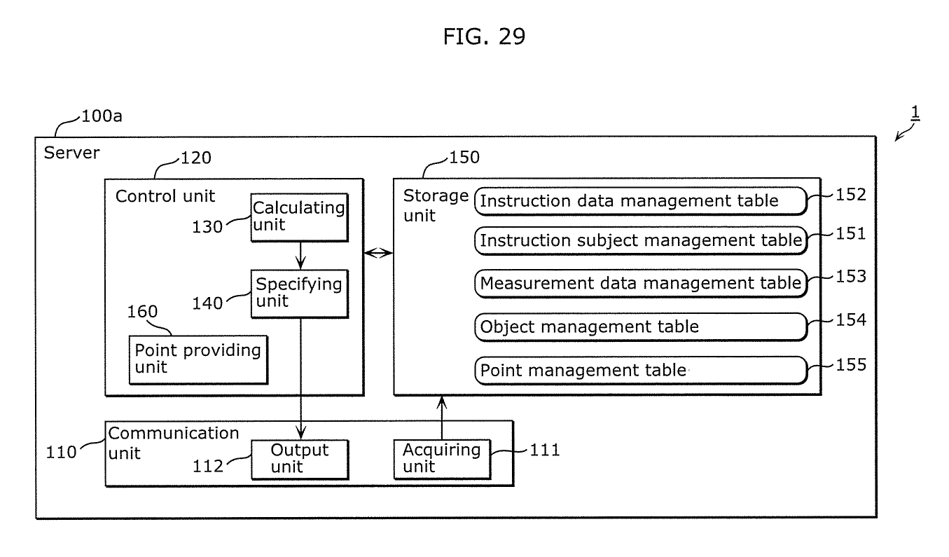

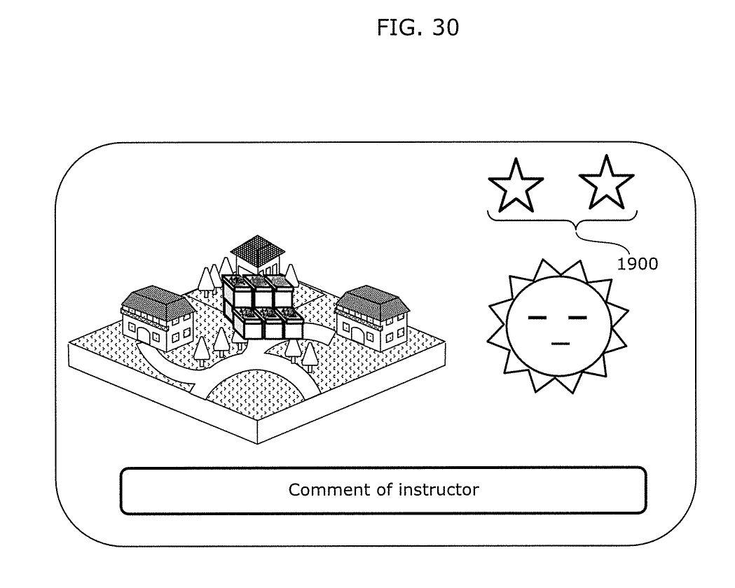

The following describes an aspect resulting from modifying part of the above-described health management system 1, with reference to FIG. 29 and FIG. 30.

A health management system according to Embodiment 2 is different from the health management system 1 according to Embodiment 1 mainly in the function of the server 100. The following describes a server 100a in the health management system according to Embodiment 2.

FIG. 29 is a functional block diagram of the server 100a according to Embodiment 2.

As illustrated in FIG. 29, the server 100a results from modifying part of the server 100 according to Embodiment 1 (see FIG. 2). In the server 100a, the control unit 120 further includes a point providing unit 160 as a functional structural element, and the storage unit 150 further stores a point management table 155. Among the structural elements of the server 100a, structural elements same as those of the server 100 are assigned with the same reference numerals and description for them will be omitted. The hardware configuration of the server 100a is the same as the hardware configuration of the server 100. The server 100a exerts a function different from the function of the server 100, by having different content of a control program which is stored in the memory 103 and to be executed by the processor 102.

The point management table 155 is a table for managing acquired points up to date of a user (instruction subject) associating the instruction subject ID with the acquired points.

The point providing unit 160 uses, for example, the continuity evaluation value (continuity parameter) of the instruction subject stored in the storage unit 150, and provides the user (instruction subject) with a point that can be used for receiving service, according to the value of the continuity parameter. The point providing unit 160 provides more points as the value of the continuity parameter is higher, for example. The server 100a transmits to the user terminal 200 an object that is an image representing the acquired points up to date when transmitting an object to the instruction subject. The user terminal 200 displays the object indicating the acquired points, and the instruction subject can check the displayed acquired points.

FIG. 30 is a diagram illustrating an example of displaying an object on the user terminal 200 according to Embodiment 2. In the example illustrated in FIG. 30, an object 1900 representing acquired points is displayed in the screen image of the user terminal 200, which indicates that two points are acquired.

The instruction subject can use predetermined services using the points. The services may be provided as a function of the health management system, or may be provided by an operator or the like of the health management system. This provides the instruction subject with motivation for measurement. It is to be noted that the point providing unit 160 may provide a point according to the evaluation parameter, tendency parameter, etc., and may provide more points as the health condition is more favorable, for example. In addition, the price charged to the user as a usage fee of the health management system or the like may be reduced according to the acquired points of the user, or health food, etc., of the price or amount according to the acquired points of the user may be provided as a present to the user.

### Embodiment 3

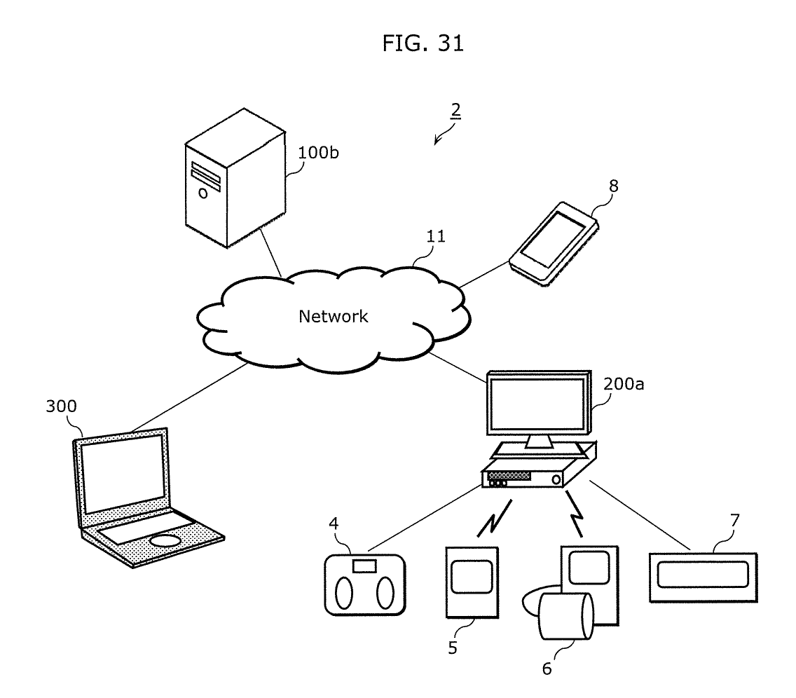

Hereafter, a health management system 2 according to Embodiment 3, which results from modifying part of the health management system 1 will be described with reference to FIG. 31 to FIG. 33.

FIG. 31 is a schematic view illustrating a configuration example of the health management system 2 according to Embodiment 3.

As illustrated in FIG. 31, the health management system 2 includes, in addition to the instructor terminal 300 as with the health management system 1 illustrated in Embodiment 1, a server 100b, a user terminal 200a, and an information terminal 8. The server 100b is capable of communicating with each of the user terminal 200a, the information terminal 8, and the instructor terminal 300 via a network 11. Among the structural elements of the health management system 2 illustrated in FIG. 31, structural elements same as those of the health management system 1 are assigned with the same reference numerals and description for them will be omitted. The server 100b has the same hardware configuration as the server 100 illustrated in Embodiment 1 and has a message transferring function in addition to the functions of the server 100. The user terminal 200a has the same hardware configuration as the user terminal 200 illustrated in Embodiment 1 and has a message displaying function in addition to the functions of the user terminal 200.

The information terminal 8 is a computer (smartphone, for example) which includes, as with the user terminal 200, a communication I/F, a processor, an input I/F, a display, a memory, etc., and has a function of displaying an object and the like, as with the user terminal 200, and a function of transmitting and receiving a message such as an email. The information terminal 8 is assumed to be used by a family member or the like who does not live with the user (instruction subject) who uses the user terminal 200a, for example.

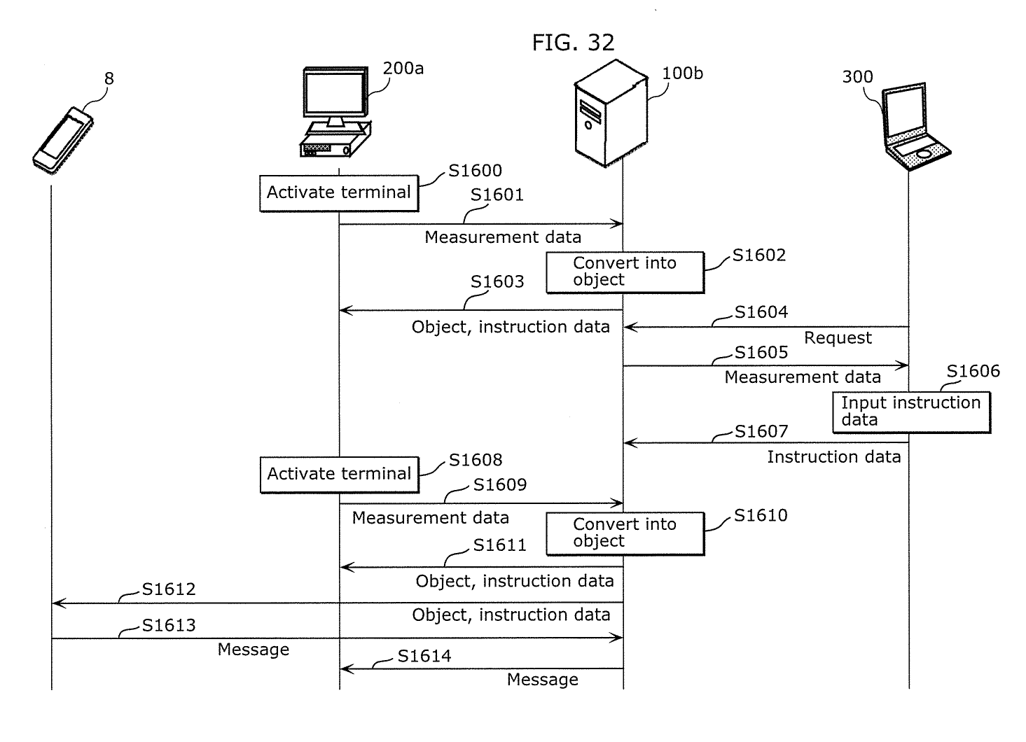

FIG. 32 is a diagram illustrating a communication sequence between the devices in the health management system 2. The following describes a cooperative operation between the user terminal 200a, the information terminal 8, the server 100b, and the instructor terminal 300 with reference to FIG. 32.

The user terminal 200a, the server 100b, and the instructor terminal 300 perform the same operations as the operations performed by the user terminal 200, the server 100, and the instructor terminal 300 of Embodiment 1 (Steps S1600 to S1611).

In addition, the server 100b transmits to the information terminal 8 the same data as an object and instruction data which are transmitted to the user terminal 200a (Step S1612). The transmission is carried out with timing according to a predetermined cycle etc., for example. However, the transmission may be carried out in synchronization with the transmission of an object or the like to the user terminal 200a. The information terminal 8 receives and displays the object and the instruction data. This allows the user (family member or the like of the instruction subject) of the information terminal 8 to know the health condition etc. of the user (instruction subject) of the user terminal 200a.

When the health condition of the instruction subject is checked and a message including comments related to health etc. to the instruction subject is input by the user of the information terminal 8, the information terminal 8 transmits the message to the server 100b (Step S1613).

The server 100b receives the message transmitted by the information terminal 8, and transmits (transfers) the message to the user terminal 200a (Step S1614). When receiving the message from the server 100b, the user terminal 200a displays, on a display, an object indicating that the message has been received.

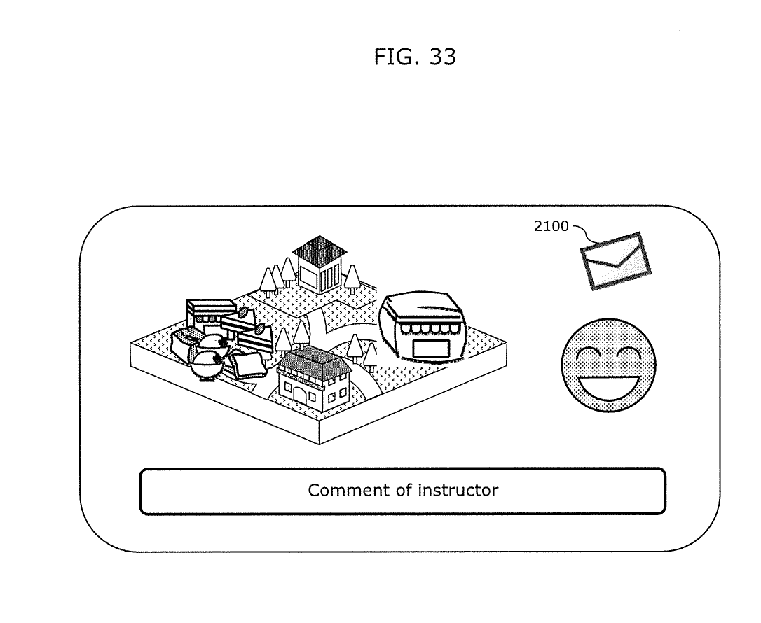

FIG. 33 is a diagram illustrating an example of displaying an object on the user terminal 200a according to Embodiment 3. In the example illustrated in FIG. 33, an object 2100 indicating that a message has been received is displayed on a screen image of the user terminal 200a. The object 2100 allows the instruction subject to notice that the message related to the health of the instruction subject (health condition, continuity of measure, etc.) has been received from the family member or the like. This provides the instruction subject with motivation for measurement.

### Other Embodiments

As described above, Embodiments 1 to 3 have been described as examples of the technique disclosed by the present application. However, the technique according to the present disclosure is not limited to the foregoing embodiments, and can also be applied to embodiments to which a change, substitution, addition, or omission is executed as necessary. The following exemplifies other embodiments.

Although an example in which one instructor is associated with an individual instruction subject is exemplified in the above-described embodiments, a plurality of instructors may be associated with an individual instruction subject.

In addition, information related to a primary care doctor specified by the instruction subject may be included and managed in the instruction subject management table. With this, when the instructor determines that doctor's diagnosis is necessary, it is possible to send data to the primary care doctor to seek the doctor's judgment. In addition, in the case where it is written by the instructor in the instruction data that consulting a doctor is required, the instruction subject, when seeing the doctor, can download and bring the measurement data in a mobile terminal, print out the downloaded data to bring, or transmit the data to the doctor via a network.

In addition, the factor object that is an image representing salt that can possibly be a factor of high blood pressure is used related to the health condition of the blood pressure according to the above-described embodiments. However, when the factor can be specified by analysis or the like of the measurement data by the instructor, an image representing the specified factor may be used as the factor object.

In addition, an image of a dam and an image of a shop are used as objects indicating the state of a blood pressure and a blood glucose level, respectively, in the above-described embodiments. However, a hose, a road, etc. may be used, for example, instead of the dam. In addition, a forest or the like may be used instead of the shop. Furthermore, although salt which can possibly be the factor of a high blood pressure and food and drink such as cake and alcohol which can possibly be the factor of a high blood glucose level, are used as objects indicating factors, a cigarette that is a human ingestible substance may be used. In this case, it is possible to use, for display, an object of which the number of cigarette butts is increased and decreased according to the value of a parameter. As described above, the object is, for example, an image representing at least one of a hose, a dam, a road, a shop, a forest, salt, sugar, rice, bread, cake, a cigarette, and an alcoholic beverage (sake, etc.).

In addition, although images of a land, a building, and the like which are included in a town are each used as an object, the object is not limited to this, and may be an image representing a shape of another substance. The substance is something that occupies a space as substantial body. Since a tangible substance is specific, it is easy for people to share recognition about a certain value according to a shape of a substance. In other words, the shape of a substance can represent a certain value and the like. For example, it is generally considered that a larger land has a higher value than a smaller one, and a building having a larger or more complicated shape has a higher value. In addition, it is generally considered that a collapsed building has a lower value than a building which is not collapsed. Thus, an advantageous effect of facilitating understanding of a user can be produced by replacing good and bad of the state of health with good and bad (i.e. value) of the state of a substance, with the conversion to an object by the health management system. In other words, when an object that is an image representing a shape of a substance indicates a health condition, an advantageous effect that the user can more intuitively comprehend the condition can be produced, compared to the case where the condition is represented by a graph, a numerical value, a character, or the like. It is to be noted that a method of representing a shape of a substance by an image is not limited to a certain method. For example, an image of an object may be a photo image of a substance, a video image of a substance, an image depicted by deforming (modifying) a shape of a substance (image depicted in the motif of a substance, for example), or may be an image such as a picture, a diagram, a mark, an illustration, etc. It is to be noted that an object of an image representing a substance with a small unit such as a grain of salt may be an image representing a shape of salt using, for example, a shape of a block, a container, etc. having a certain degree of dimensions (see FIG. 10). In addition, an object of an image representing an alcoholic beverage (liquid) such as sake may be an image representing a shape of sake using, for example, a shape of a sake decanter (container) or the like (see FIG. 11).

Furthermore, the object is not limited to an image representing a shape of a substance. It is sufficient that the object is an image representing a thing. The thing includes a substance, an event, a phenomenon, etc., and also includes a fictional substance (for example, an imaginary thing, etc.), a fictional event, and the like. The image representing a thing also includes an image representing a substance which does not have a shape. In addition, an object created in consideration of a preference of the instruction subject may be used in the health management system. For example, an object which is presented to an instruction subject who likes sports (more specifically, an object which is specified and displayed according to measurement data) may be an image representing a process of which a sport athlete (player) makes progress according to an evaluation related to the continuity of measurement or health condition of the instruction subject. In addition, the health management system may present an object such that the instruction subject can collect images related to his or her interests according to evaluation on the continuity of measurement and health condition of the instruction subject.

Furthermore, the user terminal 200 of the health management system illustrated in the above-described embodiments transmits measurement data to the server 100. In the transmission, the user terminal 200 may transmit to the server the measurement data to which a question to the instructor which is input by a user is added. In this case, the server 100 transmits the measurement data and the question from the instruction subject to the instruction subject, receives an answer to the question from the instructor transmitted via the instructor terminal 300, adds the answer to the object, and transmits the object to the user terminal 200. Then, the user terminal 200 may display the question and answer simultaneously with an object.

In addition, although the server 100 calculates the health evaluation value and the continuity evaluation value and specifies an object, based on measurement data, in the above-described embodiments, the user terminal 200 or the instructor terminal 300 may have the functions of the server 100. For example, the above-described user terminal 200 may further have the functions of the calculating unit 130, the specifying unit 140, and the storage unit 150. In this case, it is not necessary to include the server 100. In this case, in the user terminal 200 (FIG. 4) which serves as a health management apparatus that manages a health of a user, the processor 202 specifies an object which is an image representing a thing, according to a health evaluation value determined based on measurement data generated by measurement of a user, and transmits a control signal for displaying the object that has been specified on the display 204. Then, the display 204 displays an object according to a control signal which is for displaying the object and is transmitted by the processor 202. In addition, part of the functions of the server 100 may be carried out by the user terminal 200. For example, the server 100 may calculate a health evaluation value and a continuity evaluation value, and the function of the specifying unit 140 may be taken charge of by the user terminal 200. Furthermore, the server 100 may perform only management of each item of data (storage and holding), for example. In addition, the health management system may be configured without the instructor terminal 300, and in this case, an instructor may directly input instruction data (for example, instruction revision value, instruction comment, etc.) into the server 100. Furthermore, in the case where the health management system does not include the instructor terminal 300, the instruction data may not be used. In this case as well, with the health management system, an object specified according to a health evaluation value calculated based on measurement data generated by measurement of a user is displayed on the user terminal 200, and thus the user can intuitively comprehend the health condition and the like. In addition, the user terminal 200 may be integrated with a measurement device for the management to acquire management data.

In addition, in the group of management tables (instruction subject management table 151, etc.) described in the above-described embodiments, an item and a value set in the management table may be other than those described above, and may be a value of any form, for example, a numerical value, a sign, a character, etc. Furthermore, in the instruction subject management table 151, other than the blood pressure flag and the blood glucose level flag, a flag corresponding to measurement data of a different type may be included, and the blood pressure flag and the blood glucose level flag are not necessarily included. In addition, in the instruction data management table 152, a revision value such as a blood pressure revision value may be excluded from the instruction data, and a type of the measurement data which is a subject of the revision value is not limited to a blood pressure or the like.

Furthermore, the health evaluation value and the continuity evaluation value (in other words, a value of each parameter, etc.) described in the above-described embodiments is not necessarily a numerical value, and may be represented in the form of character strings, sign, etc. It is sufficient that the specifying unit 140 is capable of specifying an object based on the health evaluation value or the continuity evaluation value, in accordance with the form.

In addition, the order of executing the various processes in the health management system described in the above-described embodiments (for example, the procedures and the like illustrated in FIG. 14, FIG. 24, FIG. 27, and FIG. 32) is not limited to the order as described in the above-described embodiments, and the execution order may be changed unless such changes depart from the scope of the concept of the present disclosure.

Furthermore, the functional structural elements (functional blocks) of each of the devices according to the health management system described in the above-described embodiments may be made as separate individual chips, or as a single chip to include a part or all thereof, by a semiconductor device such as an integrated circuit (IC) and a large scale integration (LSI). Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose. Furthermore, in the future, with advancement in semiconductor technology, a brand-new technology may replace LSI. The functional blocks can be integrated using such a technology. The possibility is that the present invention is applied to biotechnology.

In addition, all or part of each processing described above (processing procedures or the like shown in FIG. 14 and FIG. 24, for example) may be executed by hardware of each device or software. It is to be noted that the execution of the processing by the software is achieved by a processor included in each device or the like executing a control program stored in a memory. In addition, the control program may be recorded on a recording medium and distributed. For instance, a distributed control program is installed into a device, and the device can be caused to execute each processing (processing or the like shown in FIG. 14 and FIG. 24) by causing a processor of the device to execute the control program.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present disclosure is applicable to a health management system that assists maintenance and improvement of health.

1. A health management system for managing health of a user, comprising:
an acquiring unit configured to acquire measurement data generated by measurement of the user;
a calculating unit configured to calculate a health evaluation value according to the measurement data acquired by the acquiring unit, based on a predetermined health evaluation standard for evaluation related to the health of the user;
a specifying unit configured to specify an object according to the health evaluation value calculated by the calculating unit, the object being an image representing a thing; and
a display unit configured to display the object specified by the specifying unit.

2. The health management system according to claim 1,
wherein the specifying unit is configured to
specify a first image representing a shape of a substance as the object when the health evaluation value is a first value, and
specify a second image representing a shape of a substance as the object when the health evaluation value is a second value different from the first value, the second image being different from the first image.

3. The health management system according to claim 2,
wherein the second image is an image representing the substance represented by the first image in a different amount.

4. The health management system according to claim 2,
wherein the specifying unit is configured to specify, as the object, an image according to the health evaluation value calculated by the calculating unit, the image representing a shape of a substance which is human ingestible and is a factor of deterioration in the health condition related to the measurement data.

5. The health management system according to claim 2,
wherein the calculating unit is configured to calculate the health evaluation value to result in a higher value as the measurement data of the user indicates a more favorable health condition, and
the specifying unit is configured to specify, as the object, an image representing a shape of a substance which has a higher value as the health evaluation value calculated by the calculating unit is higher.

6. The health management system according to claim 5,
wherein the specifying unit is configured to specify, as the object, an image corresponding to the health evaluation value calculated by the calculating unit, from among a plurality of images each representing a shape of a substance, based on association information in which the plurality of images are associated in advance on a one-to-one basis with health evaluation values such that the higher the health evaluation value is, the higher value the shape of a substance has.

7. The health management system according to claim 2,
wherein the calculating unit is configured to calculate the health evaluation value to result in a higher value as the measurement data of the user indicates a more unfavorable health condition, and
the specifying unit is configured to specify, as the object, an image representing a shape of a substance which is in a more unfavorable condition as the health evaluation value calculated by the calculating unit is higher.

8. The health management system according to claim 1,
wherein the calculating unit is configured to revise the measurement data acquired by the acquiring unit, based on an instruction revision value input by an instructor who provides a health instruction, and calculate the health evaluation value based on the predetermined health evaluation standard.

9. The health management system according to claim 1, comprising
a user terminal and a server capable of communicating with the user terminal,
wherein the server includes: the acquiring unit; the calculating unit; the specifying unit; a storage unit configured to store the measurement data acquired by the acquiring unit; and an output unit configured to transmit the object specified by the specifying unit to the user terminal,
the user terminal includes:
a communication unit configured to transmit to the server the measurement data and user identification information in association with each other, and receive the object transmitted by the output unit of the server, the measurement data being generated by the measurement of the user, the user identification information identifying the user; and
the display unit,
the display unit is configured to display the object received by the communication unit,
the acquiring unit is configured to acquire the measurement data by receiving the measurement data transmitted by the user terminal,
the storage unit is configured to store the measurement data acquired by the acquiring unit, in association with the user identification information transmitted by the user terminal in association with the measurement data,
the calculating unit is configured to calculate the health evaluation value related to the health of the user identified by the user identification information, according to the measurement data stored in the storage unit in association with the user identification information, and
the output unit is configured to transmit, to the user terminal from which the user identification information identifying the user has been transmitted, the object specified by the specifying unit according to the health evaluation value calculated by the calculating unit, the health evaluation value being related to the health of the user.

10. The health management system according to claim 9, further comprising
an instructor terminal for an instructor who provides a health instruction to input instruction data,
wherein the storage unit is further configured to store an instruction subject management table in which the instructor who provides the health instruction is associated with a user who is an instruction subject corresponding to the instructor,
the output unit is further configured to transmit the measurement data of the instruction subject corresponding to the instructor to the instructor terminal for the instructor to input the instruction data, the measurement data being stored in the storage unit,
the instructor terminal receives and displays the measurement data, and transmits to the server the instruction data which has been input,
the acquiring unit is further configured to acquire the instruction data by receiving the instruction data transmitted by the instructor terminal,
the output unit is configured to transmit the object to the user terminal together with the instruction data acquired by the acquiring unit,
the communication unit is configured to receive the instruction data transmitted by the output unit, and
the display unit is configured to display the instruction data received by the communication unit, in addition to the object received by the communication unit.

11. The health management system according to claim 1,
wherein the acquiring unit is configured to sequentially acquire the measurement data,
the calculating unit is further configured to calculate a continuity evaluation value according to an interval of acquiring of the measurement data by the acquiring unit, based on a predetermined continuity evaluation standard for evaluation related to continuity of the measurement of the user, and
the specifying unit is further configured to specify the object according to the continuity evaluation value calculated by the calculating unit.

12. The health management system according to claim 11, further comprising
a point providing unit configured to provide the user with a point usable for receiving a service, according to the continuity evaluation value.

13. The health management system according to claim 1,
wherein the measurement data is data of at least one of a blood pressure, a blood glucose level, a body weight, and an amount of physical activity.

14. The health management system according to claim 1,
wherein the object is an image representing at least one of a hose, a dam, a road, a shop, a forest, salt, sugar, rice, bread, cake, a cigarette, and an alcoholic beverage.

15. A health management apparatus for managing health of a user, comprising:
a display; and a processor,
wherein the processor specifies an object which is an image representing a thing, according to a health evaluation value determined based on measurement data generated by measurement of a user, and transmits a control signal for displaying, on the display, the object which has been specified, and
the display displays the object according to the control signal for displaying the object, the control signal being transmitted by the processor.

16. A display method performed in a health management system for managing health of a user, comprising:
acquiring measured data generated by measurement of the user;
calculating a health evaluation value according to the measured data acquired in the acquiring, based on a predetermined health evaluation standard for evaluation related to the health of the user;
specifying an object according to the health evaluation value calculated in the calculating, the object being an image representing a thing; and
displaying the object specified in the specifying.
